(19) United States
(12) Patent Application Publication
(10) Pub. No.: US 2026/0208680 A1
(43) Pub. Date: Jul. 23, 2026

(54) ROOF BASKET WITH REINFORCING RAILS

(71) Applicant: MACNEIL IP LLC, Bolingbrook, IL (US)

(72) Inventors: Trent PAULSEN, Happy Valley, OR (US); Frederick W. MASANEK, JR., Barrington, IL (US)

(73) Assignee: MACNEIL IP LLC, Bolingbrook, IL (US)

(21) Appl. No.: 19/569,754

(22) Filed: Mar. 17, 2026

Related U.S. Application Data
(63) Continuation-in-part of application No. 18/904,377, filed on Oct. 2, 2024.

(51) Int. Cl. B60R 9/045; B60R 9/05

(52) U.S. Cl. CPC B60R 9/045; B60R 9/05

(57) ABSTRACT

A vehicle roof basket is formed from a network of intersecting longitudinal and transverse beams molded of a polymer. Separately molded, modular body portions of the roof basket are assembled by fastening together male and female free ends of the beam portions. The beam portions may take the form of downwardly facing channels. On outboard longitudinal beams, reinforcing rails are fitted so as to extend over each fastening location between joined beam portions. The reinforcing rails may take the form of a channel open in an inboard direction, and may further include an upwardly extending reinforcing I beam.

This application is a continuation in part of copending U.S. patent application Ser. No. 18/904,377 filed Oct. 3, 2024, owned by the Applicant hereof. The entirety of application Ser. No. 18/904,377 is incorporated herein by reference.

### BACKGROUND OF THE INVENTION

The field of the invention relates to carriers attached to the roofs of vehicles for carrying containers, luggage and other articles thereon.

Various carriers have been devised to carry cargo on the roofs of vehicles. These include soft fabric bags, hard plastic shells and baskets. Sport utility vehicles (SUVs) commonly are equipped with roof rails, across which are affixed forward and rear crossbars. Cargo carriers of various sorts may be affixed to these crossbars.

Conventional aftermarket roof baskets or trays are fabricated of aluminum or steel, often come in several sizes so as to fit particular SUV makes and models, and are not modular. These conventional roof baskets are large, heavy pieces, and for this reason attract high shipment costs. To date, no one has attempted to fabricate a roof basket from plastic, perhaps because of the difficulty of the molding and tooling of such a large part and because, even if successfully molded, the roof basket would still occupy a large volume and the cost of shipping the part would still be large.

### SUMMARY OF THE INVENTION

The inventors have developed a kit for assembling a roof basket for a vehicle. The kit includes a first corner portion, a second corner portion directly joinable to the first corner portion, a third corner portion directly joinable to the second corner portion, and a fourth corner portion directly joinable to the first corner portion and the third corner portion. Assembly of the first, second, third and fourth corner portions will result in a completed roof basket. Each corner portion is separately injection-molded of a polymer.

In another aspect of the invention, a kit for assembling a roof basket for a vehicle comprises first, second, third and fourth corner portions. The second corner portion is displaced transversely from the first corner portion and is directly joinable to it. The third corner portion is displaced longitudinally from the second corner portion, and is directly joinable to it. The fourth corner portion is displaced transversely from the third corner portion and longitudinally from the second portion, and is directly joinable to at least one of the second and third portions. The kit further includes a first longitudinal expansion portion and a second longitudinal expansion portion. These expansion portions optionally may be used to increase an overall length of the assembled basket. If used, the first longitudinal expansion portion joins the first corner portion to the third corner portion, and the second longitudinal expansion portion joins the second corner portion to the fourth corner portion.

In similar fashion, and in a similar kit, first and second transverse expansion portions optionally may be used to increase the overall width of the assembled roof basket. When used, the first transverse expansion portion joins the first corner portion to the second corner portion, and the second transverse expansion portion joins the third corner portion to the fourth corner portion. In one embodiment, a wind deflector is provided for attachment to the front of the roof basket. The wind deflector may comprise separately molded left and right portions that are directly joinable to each other and are respectively joined to the first and second corner portions of the roof basket. The wind deflector further includes a central portion which optionally may be placed in between the left and right portions to join them together. The central portion of the wind deflector may be used when the first and second transverse expansion portions are used in assembling the roof basket.

It is even possible to expand the overall length and width of the assembled roof basket at the same time. To do this, the first longitudinal expansion portion is placed between the first corner portion and the third corner portion, the second longitudinal expansion portion is placed between the second corner portion and the fourth corner portion, the first transverse expansion portion is placed between the first corner portion and the second corner portion, and the second transverse expansion portion is placed between the third corner portion and the fourth corner portion. Optionally a center expansion portion is placed in a center so as to connect together the first and second longitudinal expansion portions, and to connect together the first and second transverse expansion portions.

In another aspect of the invention, a connector is provided for connecting first and second components of a structure. The first component includes an elongate hollow female member and the second component includes an elongate male member. The female member is arranged on an axis and has a free end. A keyhole is formed in the female member to extend from an outer surface of the female member to an inner surface thereof. A first keyhole sidewall is formed at a first angle to the axis and extends radially inwardly from the outer surface of the female member. A second keyhole sidewall is axially spaced from the first keyhole sidewall, is formed at a second angle to the axis, and extends radially inwardly from the outer surface of the female member. The male member is axially slidably received into the free end of the female member until it reaches a connection position. A mortise of the male member extends radially inwardly from an outer surface of the male member. A first sidewall of the mortise is formed at a third angle to the axis. A second sidewall of the mortise is axially spaced from the first sidewall thereof and is formed at a fourth angle to the axis. When the male member is in the connection position, the mortise is aligned with the keyhole. The connector further includes a key for joining the male member to the female member. The key is removably received into the keyhole of the female member. A tenon of the key radially inwardly extends from an inner surface of the key. A first sidewall of the tenon is formed at a fifth angle to the axis and in use fits to the first sidewall of the mortise. A second sidewall of the tenon is formed at a sixth angle to the axis, is spaced from the first sidewall thereof and in use fits to the second sidewall of the mortise. A first sidewall of the key is formed at a seventh angle to the axis and in use fits to the first sidewall of the keyhole, while a second sidewall of the key is formed at an eighth angle to the axis, is spaced from the first sidewall of the keyhole and in use first to the second sidewall of the keyhole. In one embodiment, the first through eighth angles are small drafts from planes orthogonal to the axis.

When the male member is assembled to the female member, the key will resist both horizontal tensile and compressive forces exerted on the first and second components, relieving any shear force, in either direction, that otherwise would be placed on a screw connecting the key to the male member.

In one embodiment, the structure is a vehicle roof basket, and the first and second components are portions thereof. In one embodiment, each portion comprises a plurality of elongate beams each having a free end. Some of the free ends terminate in male members as above described, while others of the free ends terminate in female members as above described. The keys are used to connect together pairs of the male and female free ends.

In one embodiment, a free end of the male member has a convexly curved transition to a top portion of the outer surface of the male member. In the case that the axis of the male member initially is misaligned to the axis of the female member, the curved transition may cam against the first sidewall of the keyhole, aiding full insertion of the male member into the female member and assumption of the predetermined connection position.

In one embodiment, the female member is a channel with a substantially open bottom. A web spans this channel to be in alignment with the keyhole and in use holds the male member in place while being affixed to the female member.

In one embodiment, a male member extends from a body of a second component. The body of the second component has a general outer surface. A general outer surface of the male member is disposed radially inwardly from the general outer surface of the second component in the vicinity of the male member. A stepped surface axially extends from the body in parallel to the general outer surface of the male member. This stepped surface is disposed radially outwardly from the general outer surface of the male member but is disposed radially inwardly from the general outer surface of the body of the second component. A majority of the inner surface of the female member is outwardly displaced from the general outer surface of the male member, such that the majority of the inner surface of the male member fits loosely with the general outer surface of the male member. But the stepped surface of the male member fits tightly to the inner surface of the female member when the male member has been inserted to the connection position. This difference in fit is tactily transmitted to the assembler and tells the assembler that the correct connection position has been achieved.

In one embodiment, a stepped ridge is formed on the inner surface of the female member so as to be spaced from the keyhole in a direction opposite the free end. The male member has a general outer surface that is radially inwardly displaced from the inner surface of the female member so that the general outer surface of the male member fits loosely with the inner surface of the female member. But the general outer surface of the male member fits tightly to the stepped ridge when the male member has been inserted to the connection position. Once again, this gives the assembler tactile evidence that the correct connection position has been achieved. These tightly fitting portions also solidify the connection, easing assembly while also reducing rattles and slop in the unit as assembled.

According to another aspect of the invention, a roof basket is provided for mounting to a roof of a vehicle. The roof basket has first, second, third and fourth crossbar mounting members. The second crossbar mounting member is spaced from the first crossbar mounting member in a transverse direction. A third crossbar mounting member is spaced from the first crossbar mounting member in a longitudinal direction that is ninety degrees from the transverse direction. The fourth crossbar mounting member is spaced from the first crossbar mounting member in both the longitudinal and transverse directions. An upper pad receptacle of the crossbar mounting member is integrally molded with a body the roof basket as using a first polymer compound.

The crossbar mounting member further includes a cross beam that is disposed below the upper pad receptacle. An upwardly facing surface of the cross beam is disposed below the upper pad receptacle. An upper pad is mounted in the upper pad receptacle and a lower pad is mounted on the upwardly facing surface of the cross beam. The upper and lower pads are molded of a second polymer compound that is softer than the first polymer compound. The upper and lower pads capture therebetween a roof rack crossbar of the vehicle, thereby fastening the roof basket to the roof of the vehicle.

In one embodiment, means for fastening the cross beam to the body of the roof basket comprises a first bolt housing integrally molded with and downwardly extending from the body and a second bolt housing integrally molded with and downwardly extending from the body, the upper pad receptacle being disposed between the first and second bolt housings. The cross beam has a first cavity that is aligned with the first bolt housing and a second cavity that is aligned with the second bolt housing. A first bolt is received in the first bolt housing and first cavity, while a second bolt is received in the second bolt housing and second cavity. In one embodiment, the first and second cavities have cross-sectional polygonal shapes that match the respective nuts threaded onto the first and second bolts.

In one embodiment, the roof basket body comprises first, second, third and fourth portions molded separately from each other and subsequently joined to each other. Each of the first, second, third and fourth crossbar mounting members affixes a respective one of the first, second, third and fourth body portions to the vehicle.

In another aspect of the invention, a roof basket for mounting to a roof of a vehicle comprises at least first and second portions. The first portion has a plurality of elongate first beams spaced from each other and disposed substantially in parallel with each other, each of the first beams having a free end. The second portion likewise has a plurality of elongate second beams which are spaced from each other, which are substantially parallel to each other and which have a free end. Each free end of the first beams may mate with and is fastenable to a respective free end of the second beams, to thereby join the first portion to the second portion. In one embodiment, some of the free ends are male free ends and others of the free ends are female free ends, each male free end being insertable into and fastenable to a respective female free end.

In one embodiment, the roof basket further comprises third and fourth portions. Each of the first through fourth portions has elongate, spaced-apart, substantially parallel longitudinal beams and elongate, spaced-apart, substantially parallel transverse beams. The transverse beams intersect and are joined to the longitudinal beams. Free ends of the transverse beams of the first portion are fastenable to respective free ends of the transverse beams of the third portion. Free ends of the longitudinal beams of the first portion are fastenable to respective free ends of the longitudinal beams of the second portion. Free ends of the transverse beams of the second portion are fastenable to respective free ends of the transverse beams of the fourth portion. Finally, free ends of the longitudinal beams of the third portion are fastenable to respective free ends of the longitudinal beams of the fourth portion.

In a further aspect of the invention, a carrier for mounting to a roof of a vehicle has a body. First, second, third and fourth crossbar mounting members are displaced from each other in longitudinal and/or transverse directions. Each crossbar mounting member includes a clamp sled affixable to the body in a selected one of a plurality of clamping positions that are longitudinally spaced from each other. A cross beam is disposed below the clamp sled, the cross beam and the clamp sled capturing therebetween a crossbar of a roof rack of the vehicle, thereby fastening the carrier to the vehicle.

In one embodiment, a downwardly facing clamp sled attachment surface of the body includes a plurality of indexing walls each formed at an angle to the horizontal and formed at an angle to the longitudinal direction. These indexing walls form a repeating pattern. An upper surface of the clamp sled has formed thereon a plurality of indexing walls each disposed at an angle to the horizontal and at an angle to the longitudinal direction. At each of the plurality of clamping positions, the indexing walls will mate with indexing walls of the clamp sled attachment surface, thereby indexing the clamp sled to a chosen one of the plurality of clamping positions.

In one embodiment, the carrier has, for each clamp sled, a clamp sled retainer or rail affixed to the lower surface of the body. The clamp sled retainer defines a slot that is parallel to the longitudinal direction. The clamp sled has a transversely extending retention flange that is wider in the transverse direction than the width in the transverse direction of the slot. The clamp sled retainer and the lower surface of the body capture the clamp sled between them.

The clamp sled retainer permits the clamp sled to assume any of a plurality of sliding positions along the slot. Ones of these sliding positions are in alignment with respective ones of the clamping positions. In any sliding position, the indexing walls of the upper surface of the clamp sled are not engaged with the indexing walls of the lower surface of the body. The clamp sled is drawn upward from a sliding position to a corresponding clamping position in order to affix the clamp sled to the body.

According to another aspect of the invention, a roof basket is provided for mounting to the roof of a vehicle. The roof basket includes first and second body portions. The first body portion has an elongate, longitudinally oriented first beam portion with a first free end, a first top surface, a first bottom end and a first side surface that extends from the first top surface to the first bottom end. The second body portion has an elongate, longitudinally oriented second beam portion with a second free end, a second top surface, a second bottom end and a second side surface that extends from the second top surface to the second bottom end. The first free end is fastened to the second free end at a first fastening location. The roof basket further has an elongate reinforcing rail that is fitted to the first beam portion and to the second beam portion, so as to extend over the first fastening location. The reinforcing rail is hollow and has a top portion, a bottom portion and a side portion which connects the top portion to the bottom portion. A lower surface of the top portion of the rail closely conforms to the first top surface of the first beam portion and to the second top surface of the second beam portion. An inner surface of the side portion of the rail closely conforms to the first side surface of the first beam portion and to the second side surface of the second beam portion. A top surface of the bottom portion of the rail adjoins the first bottom end of the first beam portion and the second bottom end of the second beam portion.

In one embodiment, the first and second beam portions have longitudinally aligned straight segments. The reinforcing rail longitudinally extends to cover substantially all of these straight segments.

In one embodiment, the roof basket is further comprised of a third body portion that is joined to the second body portion of the basket. The second beam portion has a third free end that is longitudinally spaced from the second free end. The third body portion has an elongate third beam portion with a fourth free end. The third free end is fastened to the fourth free end at a second fastening location longitudinally spaced from the first fastening location. The reinforcing rail is fitted to the first, second and third beam portions, so as to extend over the first and second fastening locations. In one embodiment, the first, second and third beam portions constitute a longitudinal beam that has a longitudinally aligned straight segment. The reinforcing rail longitudinally extends to cover substantially all of this straight segment.

In a related aspect of the invention, a carrier is provided for mounting to a rooftop of a vehicle. The carrier comprises a body molded of a polymer compound. The body includes a first body portion and a second body portion, molded separately from the first body portion, that in use is disposed to the rear of the first body portion. The first body portion has a longitudinally oriented, elongate first beam portion with a first outboard wall, a first inboard wall and a first top portion joining the first inboard and outboard walls, thereby forming a downwardly open first channel. The second body portion has a longitudinally oriented, elongate second beam portion with a second outboard wall, a second inboard wall and a second top portion joining the second inboard and outboard walls, thereby forming a downwardly open second channel. A first free end of the first beam portion is fastened to a second free end of the second beam portion at a fastening location.

An elongate reinforcing rail has a top wall, a bottom wall and a sidewall joining the top and bottom walls. The reinforcing rail extends over the fastening location. A lower surface of the top wall of the reinforcing rail fits to outer surfaces of the first and second top portions. An inner surface of the rail sidewall fits to outer surfaces of the first and second outboard walls. The bottom wall of the rail extends across the first and second channels.

In one embodiment, the body further has a third body portion molded separately from the first and second body portions. The third body portion has a longitudinally oriented third beam portion with a fourth free end. The second beam portion has a third free end longitudinally spaced from the second free end. The third free end is fastened to the fourth free end at a second fastening location spaced from the first fastening location. The reinforcing rail fits to the first, second and third beam portions so as to extend over the first and second fastening locations. In one embodiment, the first, second and third beam portions are included in a longitudinal beam with a longitudinally aligned straight segment. The reinforcing rail longitudinally extends to cover substantially all of this straight segment.

In a related aspect of the invention, a carrier is provided for mounting to a rooftop of a vehicle. The carrier comprises a body molded of a polymer compound with a first body portion and a second body portion molded separately from the first body portion and in use disposed to the rear of the first body portion. A longitudinally oriented, elongate first beam portion of the first body portion forms a downwardly open first channel. A longitudinally oriented, elongate second beam portion of the second body portion likewise forms a downwardly open second channel. Free ends of the first and second beam portions are fastened together at a fastening location. An elongate reinforcing rail, forming a channel which is open in a transverse direction, is fitted around the first and second beam portions so as to cover the fastening location.

In this and other embodiments and aspects, the reinforcing rail may further have a longitudinally elongate vertical plate upwardly extending from a top portion of the rail, to a longitudinally elongate horizontal plate. The vertical plate, horizontal plate and rail top portion form a reinforcing I-beam. Longitudinally spaced-apart slots may be formed in the vertical plate to accommodate hold-down straps.

In a still further aspect of the invention, a roof basket for mounting to the rooftop of a vehicle comprises a plurality of elongate spaced apart longitudinal beams and a plurality of elongate spaced apart transverse beams which intersect the longitudinal beams. At least the longitudinal beams are formed as downwardly open channels. The longitudinal beams include left and right outboard beams, with each outboard beam having a longitudinally aligned straight segment. For each outboard beam, a reinforcing rail longitudinally extends to cover substantially all of this straight segment. The reinforcing channel is formed as a channel open in an inboard direction and is fitted around the outboard beam.

### BRIEF DESCRIPTION OF THE DRAWINGS

Further aspects of the invention and their advantages can be discerned in the following detailed description as read in conjunction with the drawings of exemplary embodiments, in which like characters denote like parts and in which:

FIG. 1A is a top right front perspective view of a roof basket according to the invention, as mounted on a roof rack of a sport utility vehicle.

FIG. 1B is a bottom left rear perspective view of the roof basket shown in FIG. 1A, together with representative crossbars of the roof rack;

FIG. 2 is a right rear perspective view of a wind deflector making up part of the roof basket of FIGS. 1A and 1B;

FIG. 2A is a right perspective detail of a left portion of the wind deflector shown in FIG. 2;

FIG. 2B is a left perspective detail of a right portion of the wind deflector shown in FIG. 2;

FIG. 2C is a sectional detail of a representative pair of male and female connection plates for assembling the wind deflector;

FIG. 2D is a front perspective view of a second configuration of the wind deflector shown in FIG. 2, transversely expanded for use with embodiments seen in FIGS. 14 and 16;

FIG. 2E is a rear perspective view of the wind deflector in the second configuration;

FIG. 2F is a rear perspective view of a central deflector used in the second configuration;

FIG. 3 is an exploded view of the roof basket shown in FIGS. 1A and 1B;

FIG. 4A is a top perspective view of a right front corner portion of the roof basket, a left rear corner portion being substantially identical;

FIG. 4B is a bottom perspective view of the corner portion shown in FIG. 4A;

FIG. 5A is a top perspective view of a left front corner portion of the roof basket, a right rear corner portion being substantially identical to the left front corner portion;

FIG. 5B is a bottom perspective view of the corner portion shown in FIG. 5A;

FIG. 6A is a top perspective detail of a female free end of a representative one of certain beam portions making up portions of the roof basket;

FIG. 6B is a bottom perspective detail of the female free end shown in FIG. 6A;

FIG. 7A is a top perspective detail of a male free end of a representative one of certain beams making up portions of the roof basket;

FIG. 7B is a bottom perspective view of the male free end shown in FIG. 7A;

FIG. 8A is a top perspective view of a representative one of the keys used to join pairs of female and male free ends;

FIG. 8B is a bottom perspective view of the key shown in FIG. 8A;

FIG. 9 is an axial sectional detail showing a representative connection of beam portions respectively having male and female free ends, showing use of a key;

FIG. 10 is a cross sectional detail showing a male free end inserted into a corresponding female free end and disposed in a predetermined connection position;

FIG. 11A is a bottom perspective detail of a cross beam and upper component of a representative crossbar mounting member;

FIG. 11B is a cross-sectional view of a representative crossbar mounting member, shown fastened around a vehicle roof rack crossbar;

FIG. 11C is a bottom view of a representative crossbar mounting member;

FIG. 11D is a top perspective detail of an upper component of a representative crossbar mounting member;

FIG. 12 is a top right front perspective view of a modular roof basket in a “long” configuration as using two longitudinal expansion portions;

FIG. 13 is a top perspective view of a longitudinal expansion portion used to assemble the “long” roof basket configuration seen in FIG. 12;

FIG. 14 is a top right front perspective view of a modular roof basket in a “wide” configuration as using two transverse expansion portions;

FIG. 15 is a top perspective view of a transverse expansion portion used to assemble the “wide” roof basket configuration seen in FIG. 14;

FIG. 16 is a top right front perspective view of a modular roof basket in a “max” configuration as using two longitudinal expansion portions, two transverse expansion portions and a center expansion portion;

FIG. 17 is a top perspective view of a center expansion portion used to assemble the “max” roof basket configuration seen in FIG. 16;

FIG. 18A is a top front perspective view of a further embodiment of a roof carrier or basket according to the invention;

FIG. 18B is bottom rear perspective view of the roof basket shown in FIG. 18A;

FIG. 19 is a longitudinal sectional detail of the roof basket shown in FIGS. 18A and 18B, showing details of the attachment of a wind deflector or spoiler;

FIG. 20A is a top perspective detail of a further embodiment of a male free end according to the invention;

FIG. 20B is a bottom perspective detail of a further embodiment of a female free end according to the invention;

FIG. 20C is an axial sectional detail showing the male member of FIG. 20A inserted to a connection position relative to a receiving female free end similar to FIG. 20B, and showing the affixation of the two using a key and screw;

FIG. 21 is a top perspective detail of the roof basket of FIGS. 18A and 18B, showing a crossbar mounting member including a clamp sled and a cross beam;

FIG. 22 is a bottom perspective detail of the crossbar mounting member shown in FIG. 21, depicting a clamp sled, a sled retainer and a cross beam;

FIG. 23A is a longitudinal cross-sectional view of a clamp sled and cross beam capturing therebetween a crossbar of a first size, the view taken on a plane corresponding to Line 23A-23A of FIG. 25A;

FIG. 23B is a longitudinal cross-sectional view similar to FIG. 23A, but showing the clamp sled and cross beam capturing therebetween a crossbar of a second size larger than the first size;

FIG. 23C is a side perspective detail of a nut for use in fastening a cross beam to a carrier, or to a carrier and clamp sled;

FIG. 23D is a top perspective view of the nut shown in FIG. 23C;

FIG. 23E is an axial sectional view of the nut shown in FIG. 23C;

FIG. 24 is a bottom perspective view of a roof basket component used to construct the roof basket shown in FIGS. 18A and 18B, showing a clamp sled attachment surface;

FIG. 25A is a top perspective view of a clamp sled used in the embodiment shown in FIGS. 18A and 18B, showing a clamp sled upper surface;

FIG. 25B is a bottom perspective view of the clamp sled shown in FIG. 25A;

FIG. 26A is a top perspective view of a clamp sled rail or retainer for use with the clamp sled shown in FIGS. 25A and 25B;

FIG. 26B is a bottom perspective view of the clamp sled retainer shown in FIG. 26A;

FIG. 27A a longitudinal sectional view of a clamp sled and cross beam as affixing a roof basket body to a crossbar, the clamp sled affixed to the roof basket body at a first indexed position, the view being taken in a plane corresponding to Line 27A-27A of FIG. 25A;

FIG. 27B is a longitudinal sectional view of a clamp sled in a sliding position which permits the clamp sled to slide among a plurality of longitudinally spaced apart positions, the view being taken in a plane corresponding to Line 27A-27A of FIG. 25A;

FIG. 27C is a transverse sectional view of the clamp sled in a sliding position as shown in FIG. 27B;

FIG. 27D is a longitudinal sectional view of a clamp sled and cross beam as affixing a roof basket body to a crossbar, the clamp sled affixed to the roof basket body at a second indexed position that is different from the first indexed position, the view being taken in a plane corresponding to Line 27A-27A of FIG. 25A;

FIG. 28 is a top left front perspective view of a roof basket as including reinforcing rails;

FIG. 29 is a top view of the embodiment shown in FIG. 28;

FIG. 30 is a top outboard view of a reinforcing rail;

FIG. 31 is a top inboard view of the reinforcing rail shown in FIG. 30;

FIG. 32 is a schematic cross sectional view taken substantially along line 32-32 of FIG. 29;

FIG. 33 is a schematic cross sectional view taken substantially along line 33-33 of FIG. 29; and

FIG. 34 is a perspective detail, from an outboard point of view, showing the relationship of a front end of a reinforcing rail with a rear edge of the wind deflector.

### DETAILED DESCRIPTION

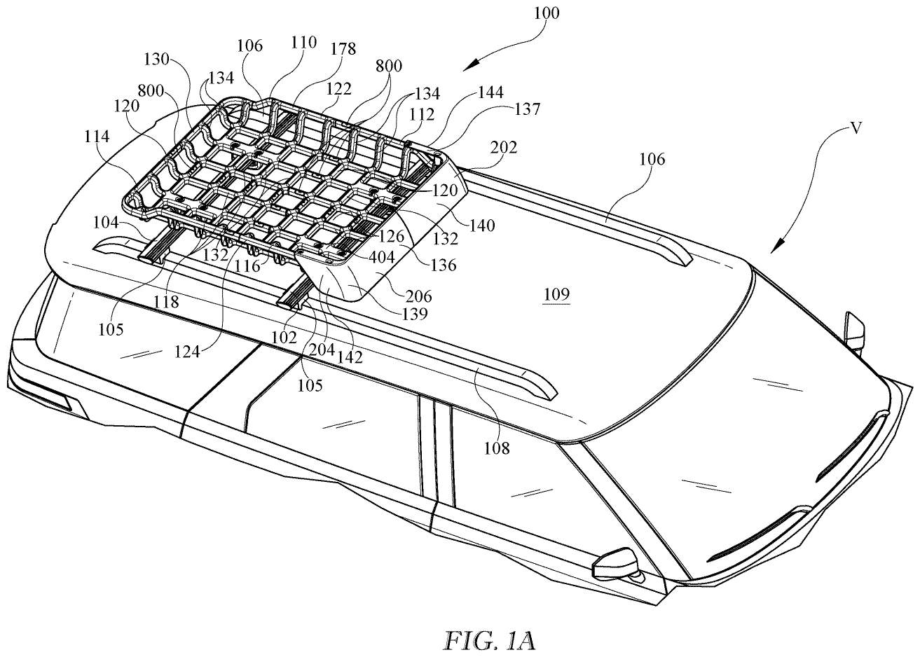

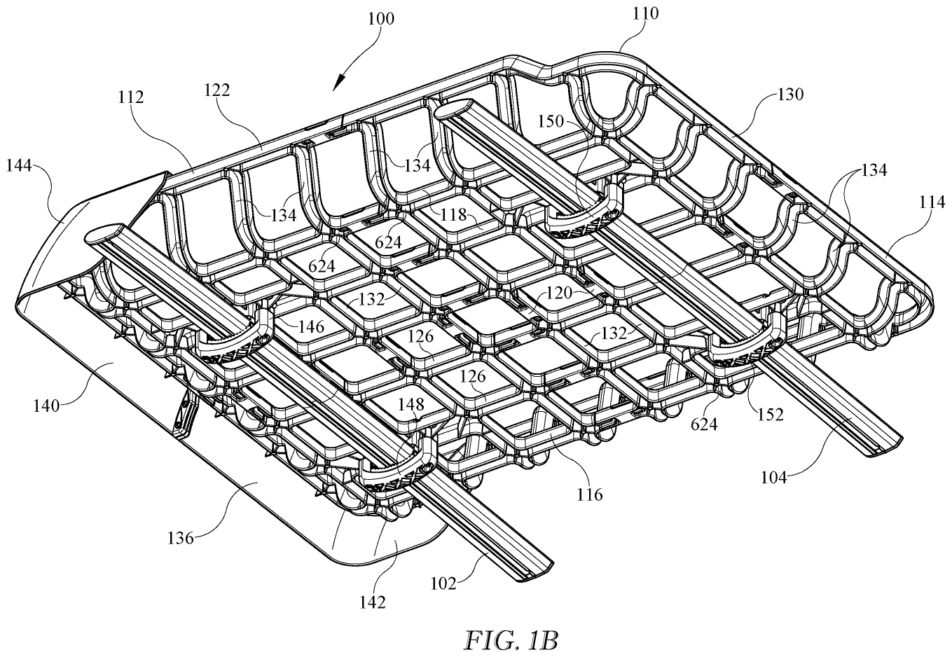

In FIG. 1A, a modular carrier or roof basket 100 according to the invention has been attached to front and rear crossbars 102, 104. The crossbars 102, 104 are commonplace roof rack accessories and are in turn fastened as by brackets 105 to left and right longitudinally oriented roof rack rails 106, 108 that in turn are mounted to a roof 109 of a vehicle V, which typically is a sport utility vehicle. The invention is applicable to any vehicle with roof rack rails or other means for attaching roof rack crossbars 102, 104 to the vehicle; some crossbars 102, 104 are attached instead to the upper window sills of passenger cars, for example. The crossbars 102, 104 are transversely oriented, parallel to each other and longitudinally spaced apart from each other. Crossbars 102, 104 may be straight or they may be slightly curved, such as upwardly convexly curved in a transverse direction.

As used herein, “longitudinal” is a horizontal direction aligned to the direction of vehicle travel (when the vehicle is traveling in a straight line) and is synonymous with fore and aft. “Transverse” is a horizontal direction at ninety degrees to the longitudinal direction and is synonymous with inboard/outboard or side-to-side. “Inboard” denotes a transverse position more toward the longitudinal axis of the vehicle, while “outboard” denotes a transverse position farther away from that axis.

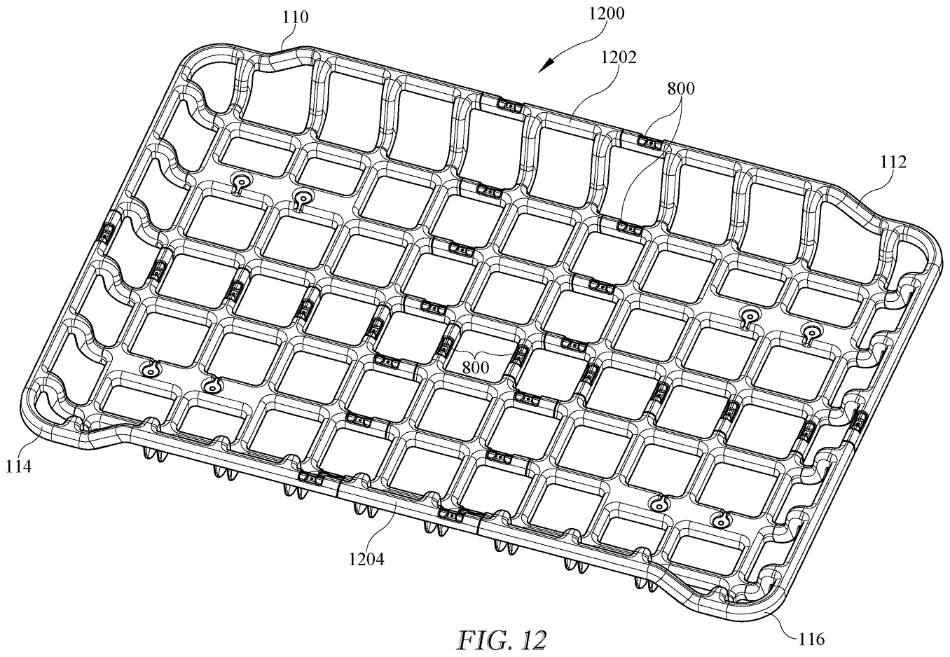

FIG. 1A illustrates a “small” configuration of roof basket 100. Basket 100 is comprised of a left rear corner portion 110, a left front corner portion 112, a right rear corner portion 114 and a right front corner portion 116. In the “small” configuration, the left rear corner portion 110 is directly fastened or joined to left front corner portion 112, the left rear corner portion 110 is directly fastened to right rear corner portion 114, the left front corner portion 112 is directly fastened to right front corner portion 116, and the right front corner portion 116 is directly fastened to right rear corner portion 114. In other configurations and as described below, the corner portions 110-116 may be joined to other ones of the corner portions 110-116 by intervening expansion portions (not shown in FIG. 1A; see FIGS. 12-17).

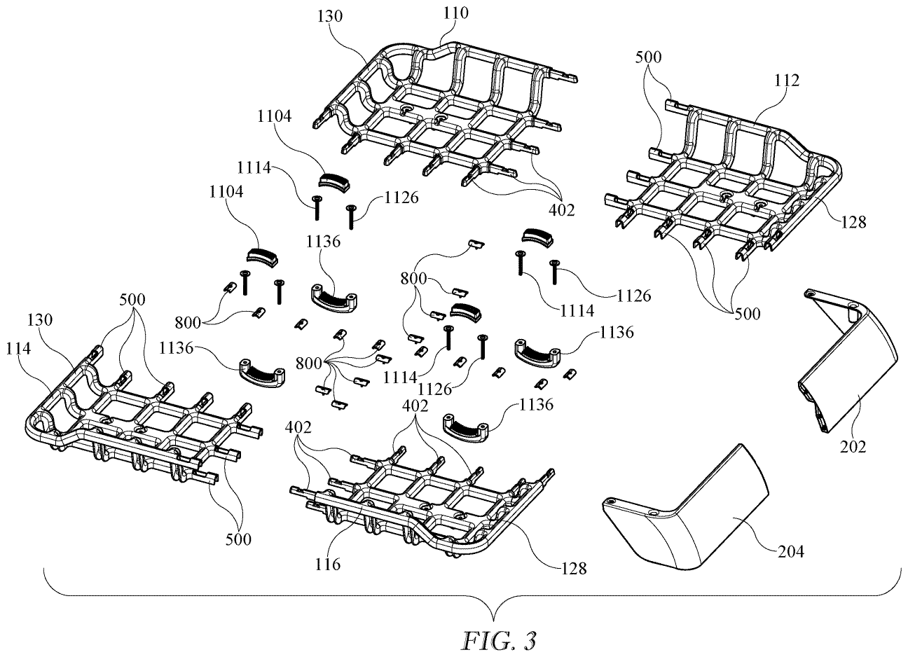

The roof basket 100 in general, and each of the corner portions 110-116 in particular, is comprised of plural longitudinal beams 118 and plural transverse beams 120. In the illustrated embodiment the longitudinal beams 118 are disposed to be in parallel to each other and are spaced from each other, the transverse beams are disposed to be in parallel to each other and are spaced from each other, and the longitudinal beams 118 intersect the transverse beams 120. Beams 118 include a left outboard beam 122 and a right outboard beam 124, and a set of intermediate beams 126 disposed in spaced relation between outboard beams 122 and 124. The longitudinal outboard beams 122 and 124 are disposed at a higher level than inboard beams 126. Similarly, transverse beams 120 include a front marginal beam 128 (see FIG. 3), a rear marginal beam 130, and a set of intermediate transverse beams 132. Other networks of beams could be devised to comprise the roof basket, and they don't have to be parallel to each other, straight or strictly aligned to longitudinal and transverse directions. But those portions of beams at which crossbar mounting members (described below) are formed should in general be arranged longitudinally.

In the illustrated embodiment, the marginal beams 122, 124, 128 and 130 are substantially coplanar and have ends that are joined to each other at the corners through curved transitions. As assembled, each intermediate beam 126, 132 has two turned-up ends 134 that join with respective marginal beams 122 and 124 or 130 and 132. The intermediate longitudinal beams 126 intersect and are joined to the intermediate transverse beams 132, so as to form a basket-like container or carrier for mounting cargo.

The basket 100 as illustrated in FIG. 1A includes a wind deflector, air dam or spoiler 136 which may take the form of a relatively thin plastic sheet. The wind deflector may be molded as a single piece, but in the illustrated embodiment comprises a left portion 202 and a right portion 204, molded separately but fastened together at their inboard ends.

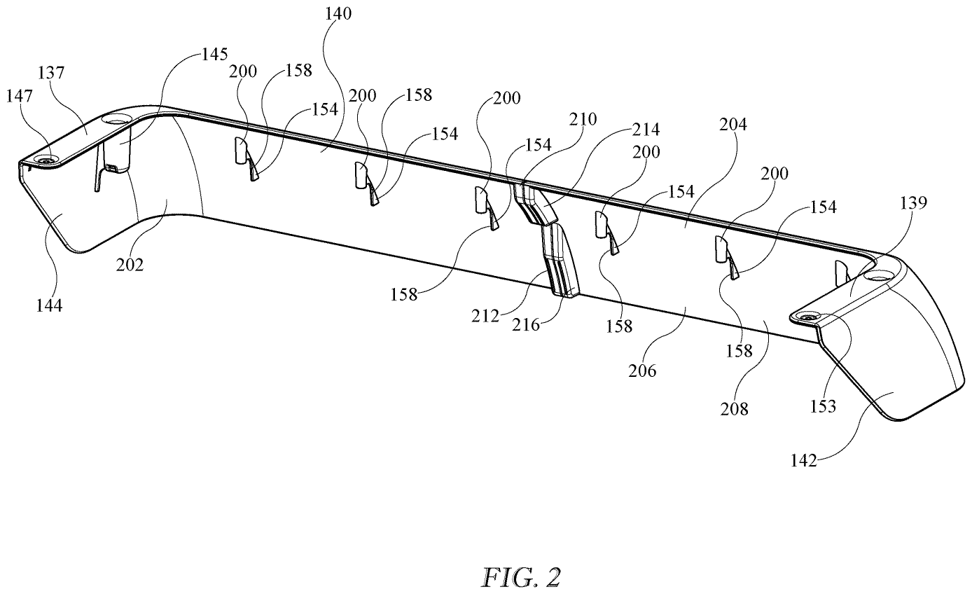

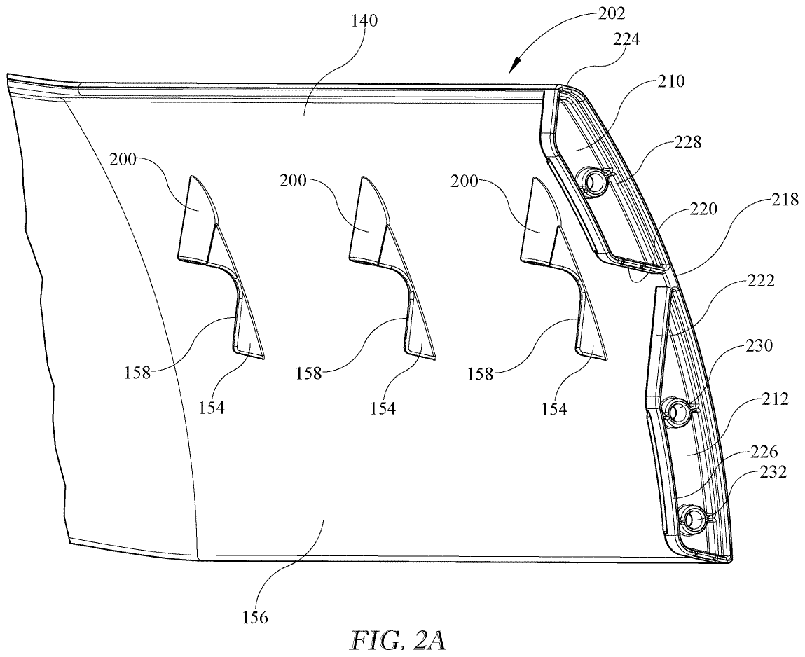

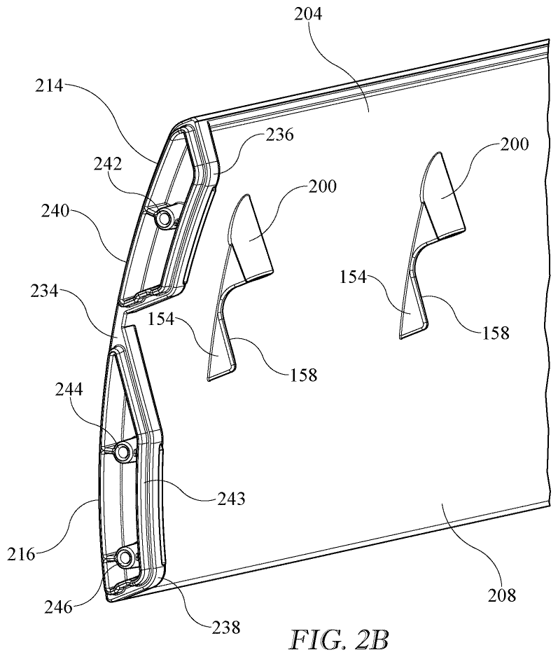

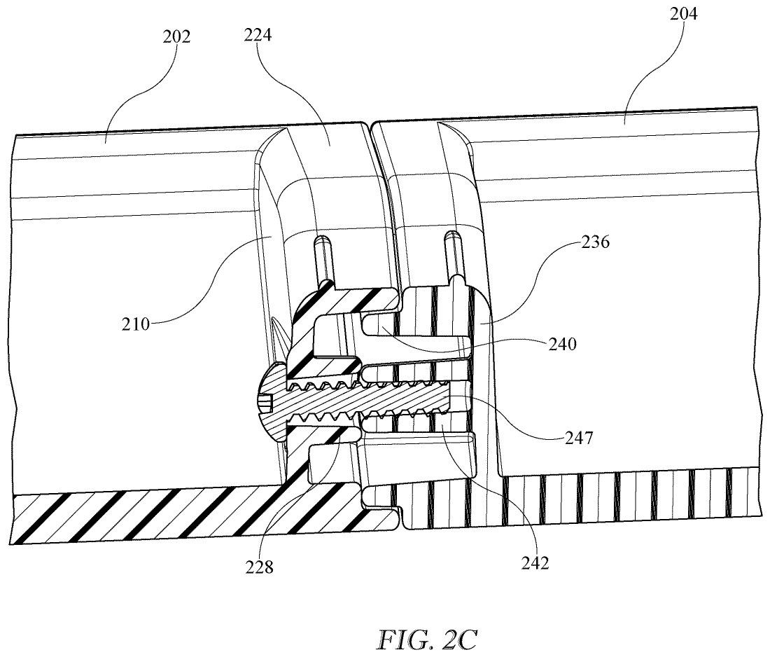

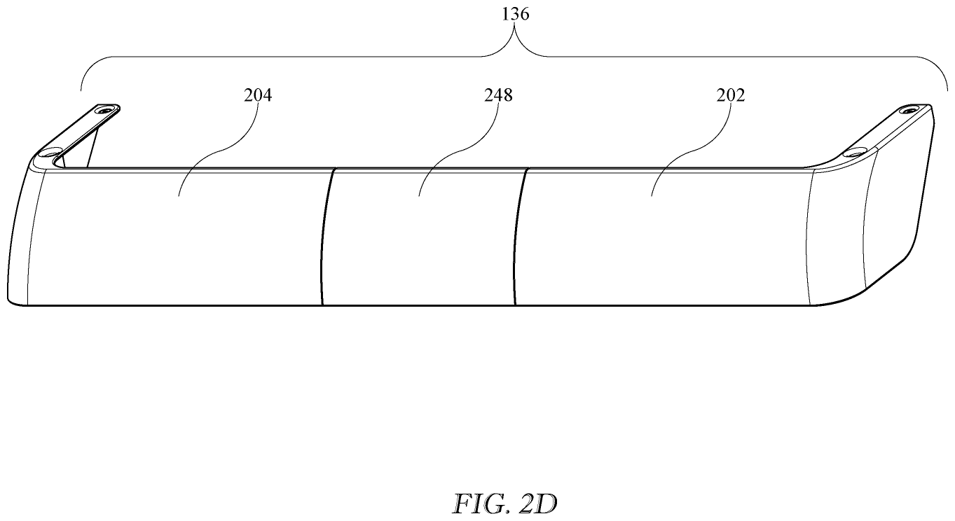

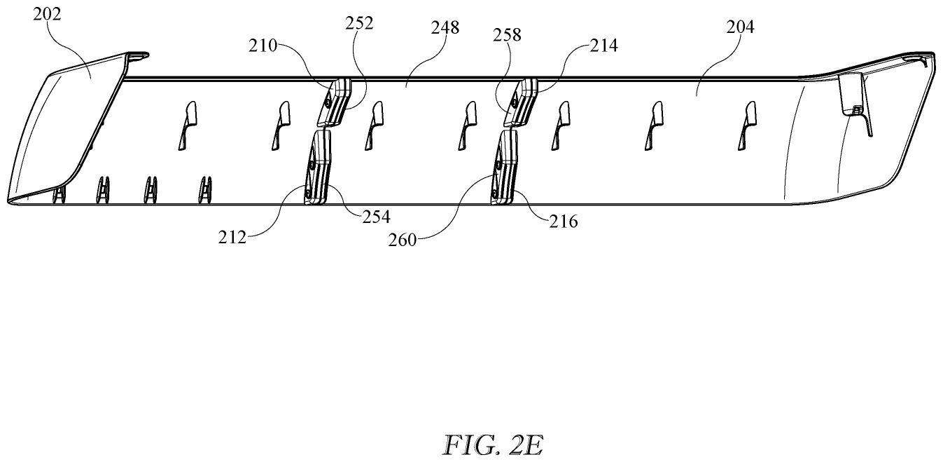

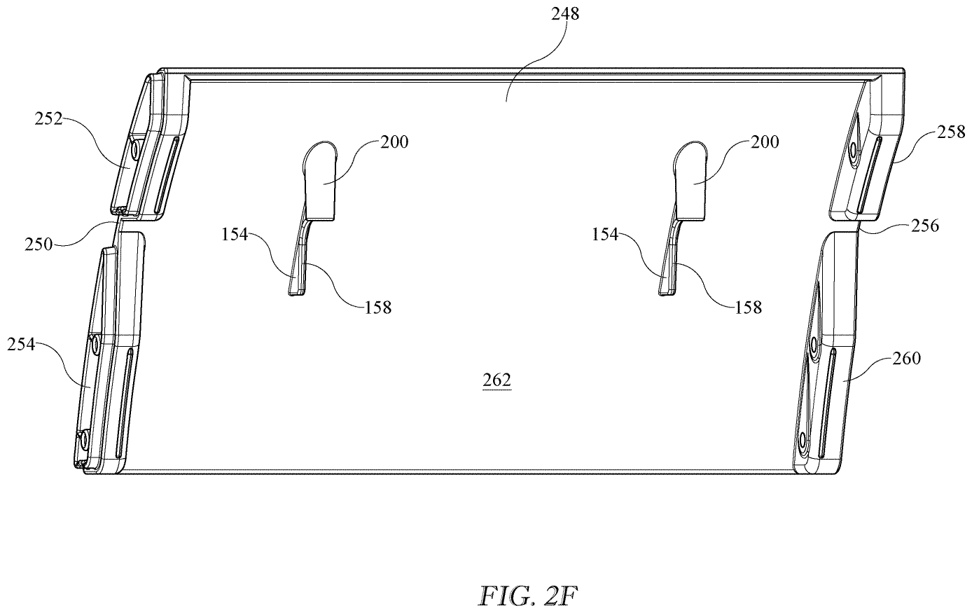

As seen in FIG. 2, the left deflector portion 202 is mostly transversely oriented but curves into a longitudinally oriented left end 144. A horizontal flange 137 extends rightwardly from a top margin of left end 144 and extends rearwardly from a top margin of front portion 140 of portion 202. A left cylindrical mounting boss 145 downwardly extends from a lower surface of left horizontal flange 137 and provides a deep recess to allow the insertion of a mounting screw (not shown) through a hole (not shown) in the bottom of the boss 145. The screw is then threaded into left outboard beam 122. A further screw (not shown) is inserted through hole 147 and is threaded into left outboard beam 122.

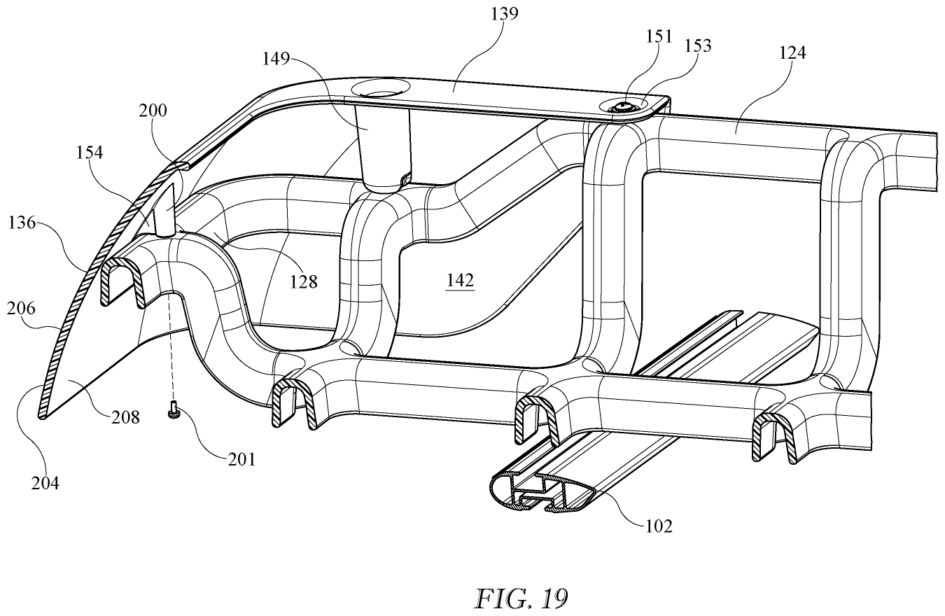

The right wind deflector portion 204 has a transversely oriented, inboard front portion 206 but curves into a longitudinally oriented right end 142. A right horizontal flange 139 extends leftwardly from a top margin of right end 142 and extends rearwardly from the top margin of front portion 206 of right portion 204. A right cylindrical mounting boss 149 (see FIG. 19) downwardly extends from right horizontal flange 139 to a top surface of right outboard beam 124. Mounting boss 149 accepts a screw (not shown) that attaches boss 149 to the right outboard beam 124. A screw 151 is inserted through right flange mounting hole 153 and into the right outboard beam 124. Overall, the wind deflector 136 may take a u-shape, as shown. The front portion 140 may be downwardly and forwardly inclined as shown.

An array of transversely spaced apart cylindrical mounting bosses 200 downwardly extend from a rear surface 156 of wind deflector front portion 140 and from a rear surface 208 of right front portion 206 until they contact an upper surface of frontmost beam 128 (FIGS. 3 and 19). Each of these bosses 200 accepts a screw (e.g. screw 201 in FIG. 19) that is threaded from the bottom of beam 128, which preferably is u-shaped and open to the bottom, into the boss 200. For each boss 200 there is an associated triangular support gusset 154 which downwardly and rearwardly extends from wind deflector rear surfaces 156 or 208. A rear edge 158 of each support gusset 154 rests on a front surface of the frontmost beam 128. Since front portions 140 and 206 are forwardly and downwardly inclined, the wind forces edges 158 into contact with the front marginal beam 128.

The left wind deflector portion 202 may be joined to right wind deflector portion 204 by a set of connection flanges 210, 212, 214 and 216. As seen in FIG. 2A, the left deflector portion 202 has an inboard end 218 at which are formed upper connection flange 210 and lower connection flange 212. Connection flanges 210 and 212 extend generally rearwardly from the rear surface 156 of left portion 202. The upper connection flange 210 has a horizontal bottom margin 220 and the lower connection flange 212 has a vertical, rearwardly facing margin segment 222. The horizontal margin 220 abuts a top surface of front beam 128 when the wind deflector 136 is assembled to the rest of the roof basket. The vertical margin segment 222 will then abut a front surface of front beam 128. The bottom margin 220 is part of a rightwardly extending circumferential lip 224. The vertical segment 222 is part of a rightwardly extending circumferential lip 226. The upper connection flange 210 has a rightwardly extending connection screw boss 228, while the lower connection flange 212 has two rightwardly extending connection screw bosses 230 and 232.

As seen in FIG. 2B, the right wind deflector portion 204 terminates in an inboard end 234, at which are disposed upper connection flange 214 and lower connection flange 216. Connection flanges 214 and 216 generally and respectively match connection flanges 210 and 212 in position and shape. Upper connection flange 214 has a leftwardly extending, circumferential, stepped lip 236. Lower connection flange 216 has a leftwardly extending, circumferential, stepped lip 238. As seen in FIG. 2C, and once left wind deflector portion 202 is assembled to right wind deflector portion 204, a terminal stepped portion 240 of lip 236 will fit inside of lip 224. Similarly, a terminal stepped portion 243 of lip 238 will fit inside of lip 226. Lips 236 and 238 therefore are male and lips 224 and 226 are female. A connection screw boss 242 of connection flange 214 will align with connection screw boss 228 of connection flange 210. Similarly, connection screw bosses 244 and 246 of lower connection flange 216 will align with connection screw bosses 230 and 232 of lower connection flange 212. A representative connection screw 247 screws together bosses 228 and 236; similar screws (not shown) are used to fasten together the other pairs of screw bosses described herein.

Since wind deflector 136 is formed in pieces 202, 204, it may be modular and has the ability to take different configurations. A transversely expanded configuration of deflector 136 is shown in FIGS. 2E and 2F. In this configuration, left and right portions 202 and 204 are not directly joined together, but rather by means of an interposed central deflector portion 248. As seen in FIG. 2F, central portion 248 has a left end 250 at which are disposed upper and lower connection flanges 252 and 254, and a right end 256 at which are disposed right upper and lower connection flanges 258 and 260. Left upper and left lower connection flanges 252 and 254 are respectively identical in all respects to right portion connection flanges 214 and 216 of right portion 204. Right upper and right lower connection flanges are respectively identical in all respects to left portion connection flanges 210 and 212 of left portion 202.

As seem in FIG. 2F, the central deflector portion 248 has a rear surface 262 from which downwardly extends a pair of spaced-apart mounting bosses 200, similar in form and function to the other deflector mounting bosses 200 described here. Also similar are associated, vertically oriented triangular gussets 154 which rearwardly extend from the surface 262 and have rear vertical edges 158 which will abut beam 1406 (described below) when the deflector is mounted to the rest of the transversely expanded roof basket.

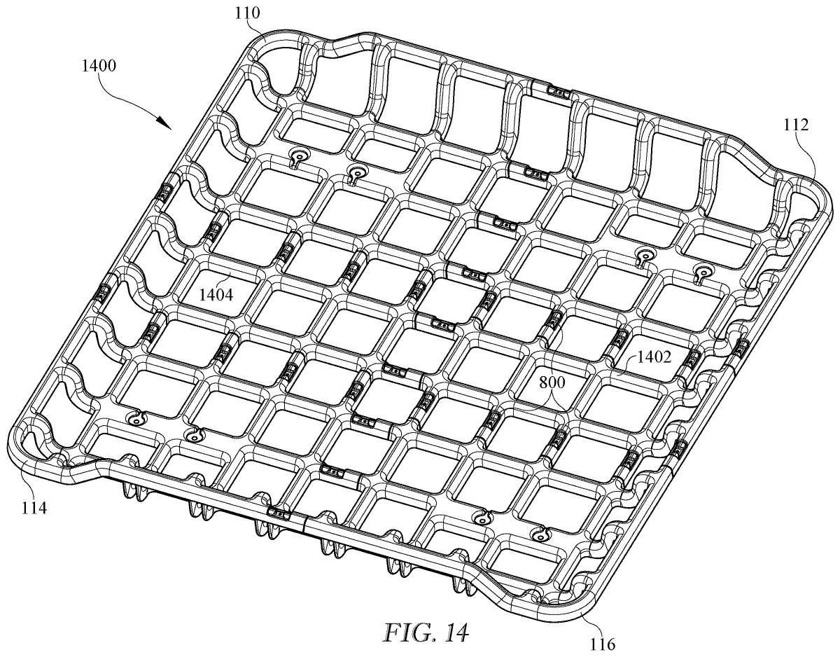

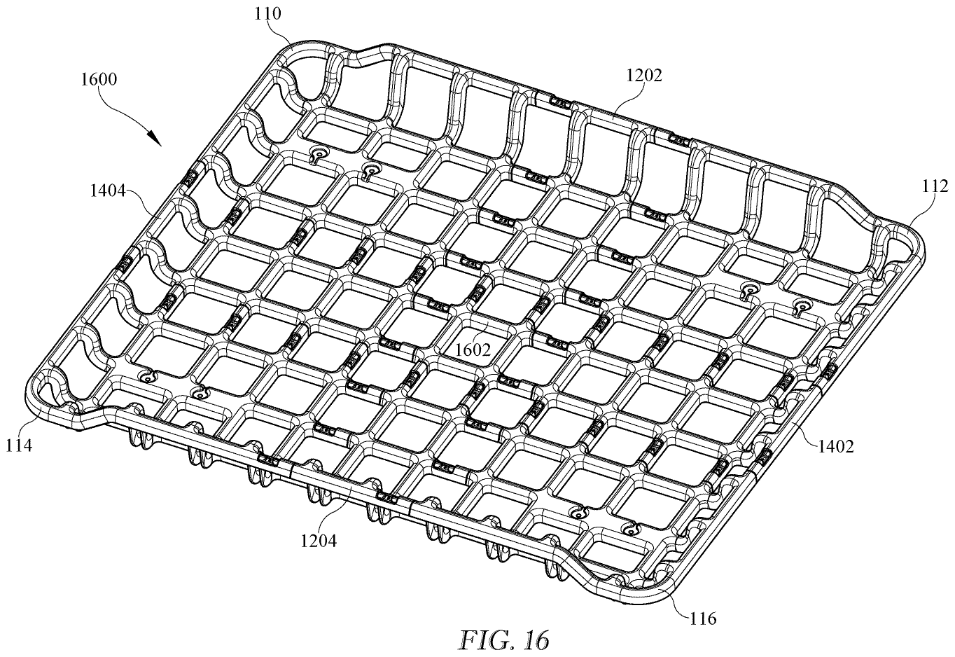

The transversely expanded wind deflector seen in FIGS. 2E and 2F is suitable for assembly to or incorporation into transversely expanded “wide” roof basket configuration 1400 (FIG. 14), and into “max” roof basket configuration 1600 (FIG. 16).

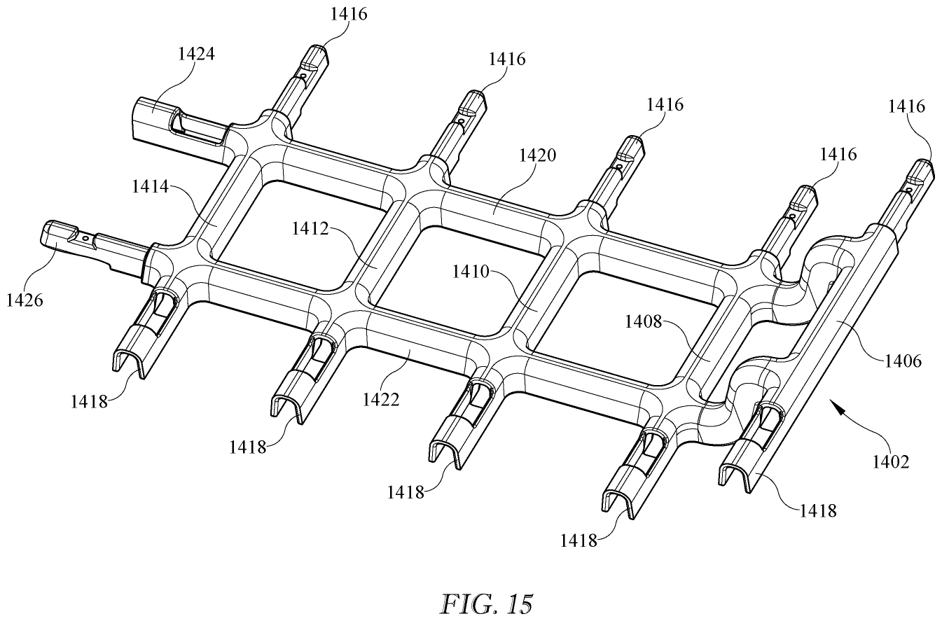

FIG. 19 is a detail showing how the wind deflector 136 is fastened to the rest of the roof basket 100. A respective screw 201 is threaded through a peripheral beam and into each boss 200. A screw (not shown) is inserted into the depression formed by right cylindrical mounting boss 149, through a hole (not shown) in its bottom and then threaded into right marginal beam 124. A screw 151 is fastened directly to right marginal beam 124. Similar fastening arrangements (not shown) may be made for the left deflector portion 202. The center deflector portion 248, if used, is attached to transverse beam portion 1406 of transverse expansion portion 1402 (FIG. 15) by screws (not shown) threaded through beam portion 1406 into the respective mounting bosses 200 of portion 248 (FIG. 2F).

As seen in FIG. 1B, the basket 100 is affixed to crossbars 102, 104 (and thence to vehicle V) by crossbar mounting members 146, 148, 150 and 152. In this illustrated embodiment one such crossbar mounting member 146-152 is provided for each corner portion 110-116. In particular, crossbar mounting member 146 affixes left front corner portion 112 to crossbar 102. Crossbar mounting member 148 affixes right front corner portion 116 to front crossbar 102. Crossbar mounting member 150 affixes left rear corner portion 110 to rear crossbar 104. And crossbar mounting member 152 affixes right rear corner portion 114 to rear crossbar 104. In this way, each corner portion 110-116 is directly affixed to a crossbar 102 or 104 without depending on any neighboring basket portions. In other embodiments, further crossbar mounting members may be provided. The crossbar mounting members 146-152 are all spaced from each other, in a longitudinal direction, a transverse direction or both. Left front crossbar mounting member 146 is spaced forwardly from left rear crossbar mounting member 150 and leftwardly from right front crossbar mounting member 148. Right front crossbar mounting member 148 is forwardly spaced from right rear crossbar mounting member 152. Right rear crossbar mounting member 152 is rightwardly spaced from left rear crossbar mounting member 150.

The crossbar mounting members 146-152 alternatively may be used to fasten roof carriers or baskets of other kinds to crossbars 102, 104. For example, they may be used with roof carriers made of solid sheets or with roof baskets that are of single-piece, non-modular construction.

In the illustrated embodiment, each of the longitudinal beams 118 and transverse beams 120 is hollow and takes the form of a downwardly facing u-shaped channel with a substantially open bottom. This form aids in moldability from plastic, increases the strength/weight ratio, and makes the beams 118, 120 easier to fasten together.

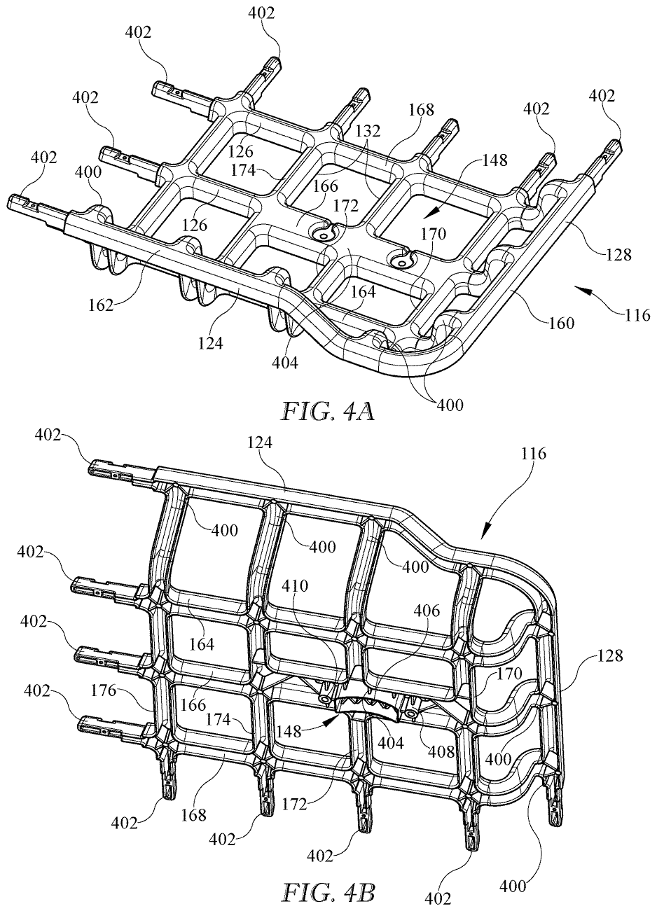

A detail of right front basket corner portion 116 is shown in FIGS. 4A and 4B. In the illustrated embodiment, the right front corner portion 116 is substantially identical to left rear corner portion 110. A transverse beam portion 160 makes up a rightmost portion of front marginal beam 128. A longitudinal beam portion 162 makes up a forwardmost portion of right outboard beam 124. Corner portion 116 further includes, from bottom to top in FIG. 4A but from right to left as assembled, intermediate longitudinal beam portions 164, 166 and 168, and, from left to right but from forward to rear as assembled, intermediate transverse beam portions 170, 172, 174 and 176. In the illustrated embodiment, and for each basket portion, the longitudinal beam portions intersect and are integrally molded with the transverse beam portions.

Each of the beam portions 160-176 has a first end 400 that is integrally molded with and joins one of the marginal beam portions 160 and 162, and a second, free, male end 402 opposed to the first end 400. In the illustrated embodiment each of the male free ends 402 is identical to the others.

In this embodiment, an upper component 404 of the front right crossbar mounting member 148 is integrally molded as an enlargement of intermediate longitudinal beam 166. As seen in FIG. 4B, the upper component 404 includes an upper pad receptacle 406 that downwardly extends from an intersection of beam portions 166 and 172, a front bolt housing 408 disposed forwardly of upper pad receptacle 406, and a rear bolt housing 410 disposed rearwardly of upper pad receptacle 406. The front and rear bolt housings 408 and 410 downwardly extend from beam portion 166.

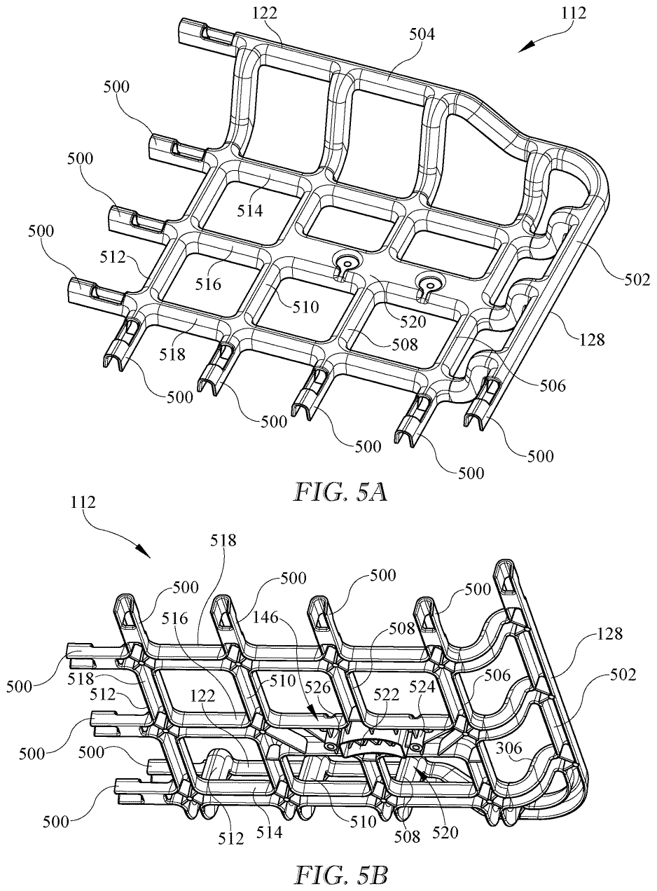

A detail of left front corner basket portion 112 is shown in FIGS. 5A and 5B. In the illustrated embodiment, right rear corner basket portion 114 is substantially identical to left front portion 112. Portion 112 is a mirror image of right front basket portion 116—with the exception that male free ends 402 have been replaced with female free ends 500. In the illustrated embodiment each female free end 500 is identical to the others.

A front left marginal beam portion 502 is fastenable to right front marginal beam portion 160 (FIG. 4A) to complete (in the “small” configuration) the front marginal beam 128. A left front outboard longitudinal beam portion 504 is fastenable to a left rear longitudinal outboard beam portion 178 (FIG. 1A) to complete the left marginal beam 122. Corner basket portion 112 has four transverse intermediate beam portions 506, 508, 510 and 512 that are respectively connectable to transverse beam portions 170, 172, 174 and 176 of basket portion 116 to complete four transverse beams. Intersecting these are three longitudinal inboard beam portions 514, 516 and 518. Those are connectable to other male-terminated longitudinal inboard beam portions of basket corner portion 110 to complete three intermediate longitudinal beams 126.

In this embodiment, an upper component 520 of the crossbar affixation member 146 is integrally molded as an enlargement of longitudinal intermediate beam portion 516. The upper component 520 includes an upper pad receptacle 522 (FIG. 5B) that is disposed between a front bolt housing 524 and a rear bolt housing 526. Bolt housings 524 and 526, and upper pad receptacle 522, all downwardly extend from beam portion 516. As can be seen, crossbar affixation member upper component 520 may be identical in structure to crossbar affixation member upper component 404.

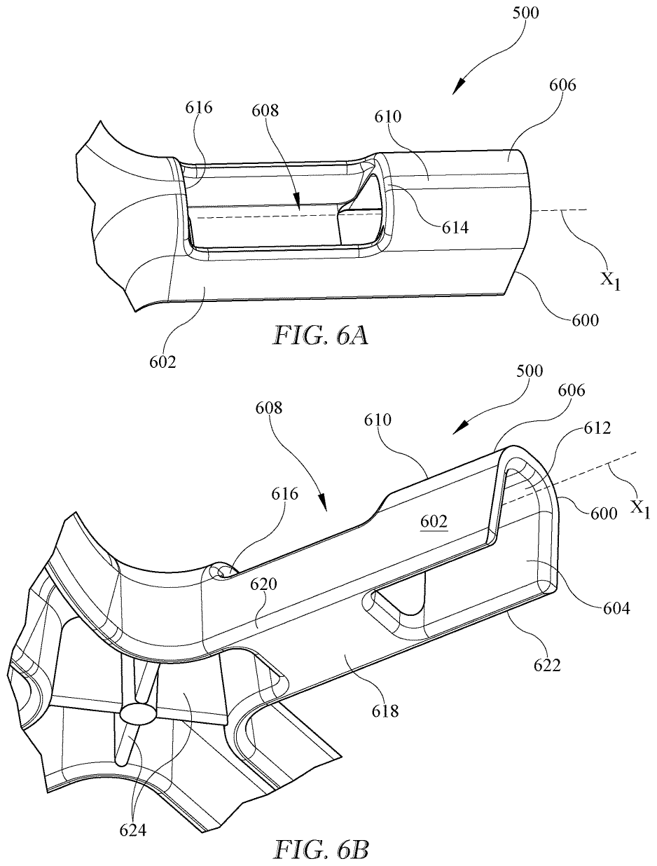

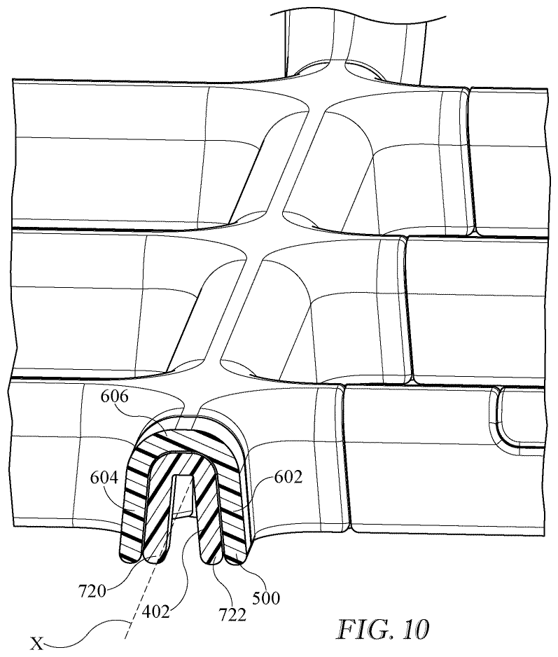

A representative female free end 500 is shown in detail in FIGS. 6A and 6B. Free end 500 extends to an end surface 600 and is formed around an axis X₁. In the illustrated embodiment the end surface 600 is not perpendicular to axis X₁ but rather is canted downwardly and away or proximally from the free end (leftward in FIGS. 6A and 6B). The female free end 500 may have side walls 602, 604 that are parallel to axis X₁ but which are not strictly vertical or parallel to each other. For ease in molding and assembly, walls 602 604 may be angled with the respect to the vertical, such as by a draft angle selected from the range of 3 to 15 degrees, and in one embodiment 5 degrees. See also FIG. 10. A convex top portion 606 joins side wall 602 to side wall 604 to create a u-shaped hollow interior.

A key hole 608 is formed from the top surface 610 of the top portion 606 through to an inner surface 612 thereof. The key hole 608 has a distal end wall 614 that is not quite perpendicular to axis X₁ but rather is downwardly and proximally angled by an angle selected from the range of ______ to ______ degrees, and in one embodiment ______ degrees. Spaced from end wall 614 is a keyhole proximal end wall 616 that also is formed at an angle to axis X₁. End wall 616 may be downwardly and distally angled by an angle selected from the range of 3 to 15 degrees, and in one embodiment 5 degrees. The angles of end walls 614 and 616 may be the same but in opposite proximal/distal directions.

As is best seen in FIG. 6B, female free end 500 can be a hollow u-shaped channel, with a mostly open bottom. In this, the female free end 500 is a continuation of the open-bottom channel that forms the beam portion that female free end 500 terminates. However, a horizontal web 618 connects a bottom margin 620 of side wall 602 to a bottom margin 622 of side wall 604, at a location vertically aligned with key hole 608. Also visible in FIG. 6B are examples of numerous reinforcing ribs 624 that may be formed in various vertical planes and which reinforce the otherwise hollow beams at points of stress. Ribs 624 may, for example, be arranged as intersecting “X” and may be formed at intersections of longitudinal beam portions and transverse beam portions as seen in FIG. 1B.

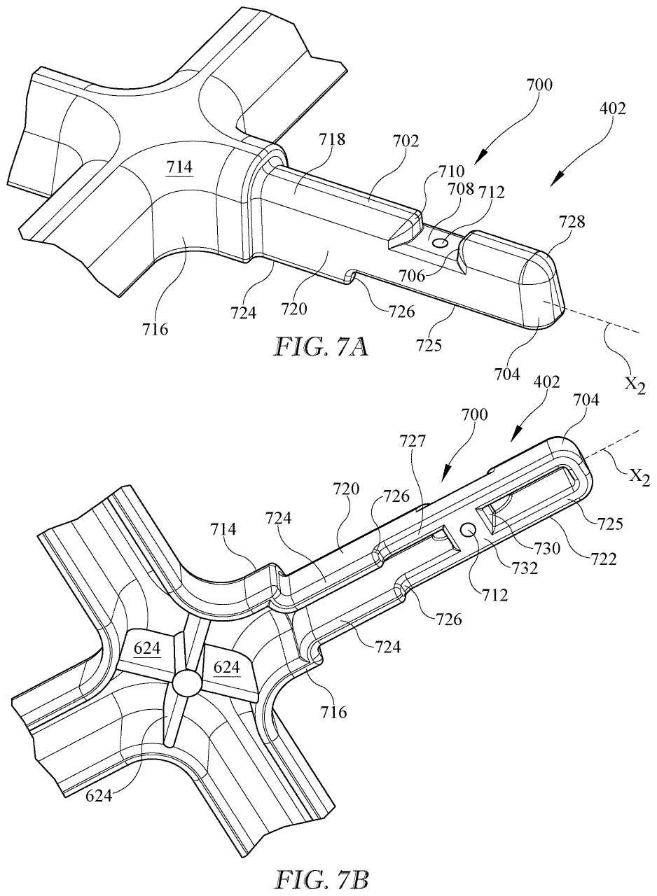

A representative male free end 402 is illustrated in detail in FIGS. 7A and 7B. Male free end 402 is formed on an axis X₂. A mortise 700 downwardly extends from an upwardly convex outer surface 702. The mortise 700 is spaced in a proximal direction from a male free end convexly curved distal end surface 704. Mortise 700 may take the form of an open slot and is defined by a distal end wall 706, a substantially horizontal flat bottom surface 708 aligned with axis X₂, and a proximal end wall 710 that is spaced from the distal end wall 706 by the bottom surface 708. In other embodiments mortise 700 may have longitudinal side walls and may be roughly square or rectangular. Proximal and distal end walls 706 and 710 may be formed at an angle that is from 0 to 15 degrees to a plane orthogonal to axis X₂. If walls 706, 710 have a nonzero draft, they will be slanted radially inwardly and downwardly and toward each other. Walls 706, 710 may be convexly curved relative to a center of mortise 700 rather than planar. A fastening screw hole 712 begins at or near a center of mortise bottom surface 708 and is perpendicular to axis X₂.

The longitudinal beams 118 and transverse beams 120 preferably are molded such that their walls conform to a predetermined nominal thickness wherever possible. The male and female free ends 402, 500 likewise have this characteristic, as seen for example in FIG. 10. This nominal thickness may, for example, be about 0.180 in. The nominal thickness used will vary inversely as a function of the strength of the polymer compound from which basket portions 110-116 is molded. In this embodiment, the outer surface 702 of male free end 402 is stepped radially inwardly from an outer surface 714 of the beam 716 from which male free end 402 extends. The amount of this step will be slightly more than the nominal thickness used to mold the roof basket 100. This is so that the male end 402 may fit inside of a respective female end 500 when ends 402, 500 are fastened together, as seen in FIG. 10.

Male free end 402 includes a upwardly convexly curved top portion 718 and side walls 720, 722 downwardly extending therefrom. The side walls 720, 722 and curved top portion 718 are aligned with axis X₂. Each side wall 720, 722 may not be vertical but may instead extend downwardly and radially outwardly by a draft in the range of 1 to 15 degrees, and in the illustrated embodiment 5 degrees. This degree of draft may match the draft of female free end side walls 602 and 604, as shown in FIG. 10. Each side wall 720 extends from curved top portion 718 to a bottom margin 724. The margin 724 is not straight but is upwardly stepped through a distal portion 725 thereof. The amount of the step 726 is a little more than the nominal thickness used in molding each basket portion, so as to accommodate the thickness of female free end web 618.

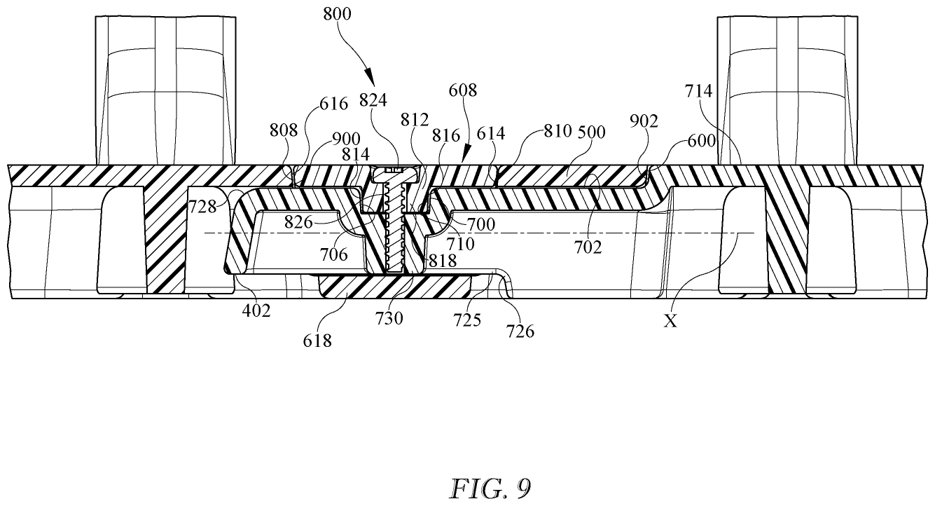

In the illustrated embodiment, the distal end surface 704 is also convexly curved in a vertical plane containing axis X₂. This creates an upwardly convexly curved transition 728 to outer surface 702 of top portion 718. This camming surface 728 is used to aid the insertion of the male free end 402 into a respective female free end 500 until a predetermined connection position is achieved. In the connection position, and as seen in FIG. 9, axes X₁ and X₂ become segments of an assembled beam axis X. But, during insertion, axis X₂ may not be initially aligned with axis X₁, but may instead extend distally and upwardly instead of just distally and horizontally. When this happens, the camming surface 728 of male free end 402 will hit a bottom edge 900 of keyhole proximal end wall 616. Further axial force tending to displace male free end 402 into female free end 500 will cause the camming surface 728 to cam against bottom edge 900, rotating axis X₂ downward until it is aligned with axis X₁, and permitting the further inward displacement of free end 402 relative to female free end 500 until the predetermined connection position seen in FIG. 9 has been achieved.

As seen in FIG. 7B, the screw hole 712 is housed in and defined by a screw housing 730, which may downwardly extend from mortise surface 708 to a bottom surface 732 coplanar with the stepped margin 727. The rest of male free end 402 may be hollow.

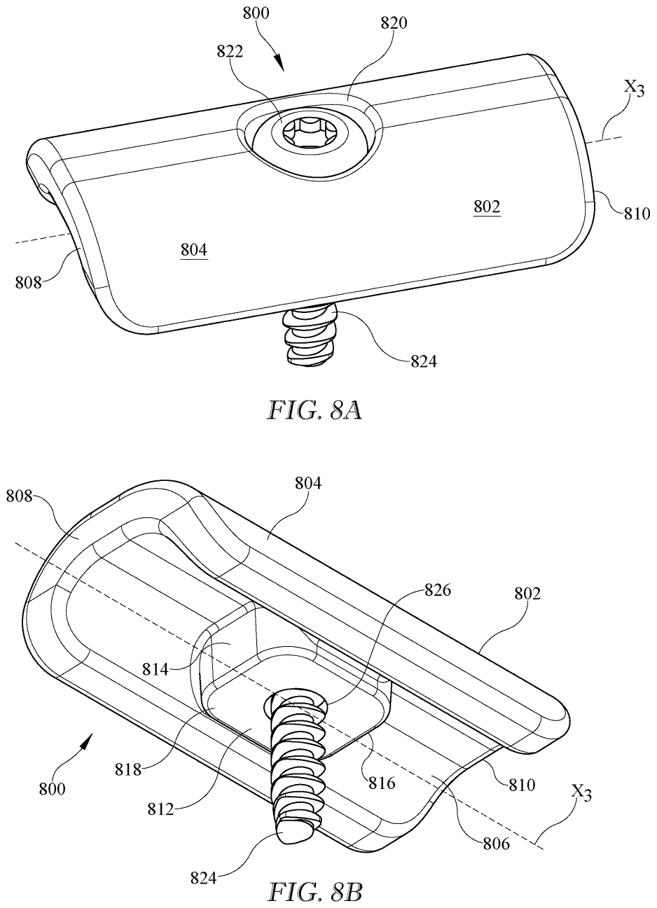

In the illustrated embodiments a key 800, as seen in FIGS. 8A and 8B, is used to fasten each female free end 500 to a respective male free end 402. The key 800 is formed around an axis X₃, which when the key 800 is assembled to ends 402 and 500 will be colinear with axes X₁ and X₂. The key 800 has an upwardly convex body 802 with a thickness similar to the nominal thickness used in specifying the substantially hollow channels making up each longitudinal beam 118 and each transverse beam 120. An upper surface 804 of body 802 is meant to conform to female free end upper surface 610 once installed. A lower surface 806 (FIG. 8B) of body 802 is likewise upwardly convex, and is meant to conform to male free end outer surface 702 once installed. Key 800 has opposed end walls 808, 810 which can be mirror images of each other and which downwardly extend from upper surface 804 to lower surface 806. In the illustrated embodiment, end walls 808, 810 are not perpendicular to axis X₃ but are slightly angled downward and toward the center of key 800. The draft of end walls 808, 810 may be in the range of 1 to 15 degrees relative to the perpendicular, and in the illustrated embodiment is 5 degrees. The draft of end walls 808, 810 may be chosen to match the draft(s) of keyhole end walls 614 and 616.

As seen in particular in FIG. 8B, a tenon 812 downwardly extends from key body lower surface 806. Tenon 812 has a first end wall 814 that is formed at an angle to axis X₃, and a second end wall 816 that can be a mirror image of first end wall 814. A flat, horizontal bottom surface 818 joins end wall 814 to end wall 816. The end walls 814, 816 are spaced apart from each other and may have a draft that is downward and inward toward the center of the key 800. The draft may be in the range of 0 to 15 degrees relative to a plane orthogonal to axis X₃, and in the illustrated embodiment is 3 degrees. The draft(s) of tenon end walls 814, 816 may be chosen to match the draft(s) of mortise end walls 706, 710.

A screw head counterbore 820 (FIG. 8A) may be formed in top surface 804 to downwardly extend therefrom, so as to accommodate a head 822 of a fastening screw 824. A screw hole 826 extends from a bottom surface of the countersink 820 to tenon lower surface 818. Key 800 may be molded of a polymer, or alternatively may be die cast metal.

FIG. 9 is an axial cross-sectional view showing the assembly of a representative male free end 402 to a female free end 500, using a key 800. The male free end 402 has been inserted into the female free end 500 until it arrives at a predetermined connection position, as shown. The connection position may be indexed by the abutment of female end surface 600 with a step 902 between male end outer surface 702 and the general beam outer surface 714. The web 618 of female end 500 captures and holds in place the male free end 402 by way of male free end lower margin distal segment 725.

To assemble, a male free end 402 is fully inserted into a female free end until a predetermined connection position is achieved. Then, the key 800 is dropped into the female end key hole 608, and key tenon 712 is fitted into male end mortise 700. The screw 824 is screwed through tenon 812 and screw housing 730.

The parts interact as follows. When male end 402 is pulled rightward (in this view) with a tensile force relative to female end 500, mortise wall 706 contacts tenon wall 814. That in turn will cause key end wall 810 to contact distal key hole wall 614, resisting the tensile force. On the other hand, when male end 402 is pushed (leftward in this view) further into female end 500 with a relative compressive force, mortise end wall 710 impacts tenon end wall 818. That in turn causes key end wall 808 to contact key hole wall 616, resisting the compressive force. In this manner, tensile and compressive forces are resisted over sizeable key, mortise, tenon and key hole end wall surface areas. The key 800 substantially relieves any shear force which may be experienced by screw 824. Screw 824 only has to fasten together key 800, male free end 402 and female free end 500 in a direction perpendicular to the axis on which such tensile and compressive forces will be experienced.

In its “small” configuration (FIGS. 1A, 1B and 3), roof basket 100 uses eighteen such male/female/key connections (402, 500, 800) to connect together the four corner portions 110-116. In the “long”, “wide” and “max” configurations (all described below), there are more. In the illustrated embodiment, all such connections are identical to each other, which simplifies manufacturing and assembly requirements.

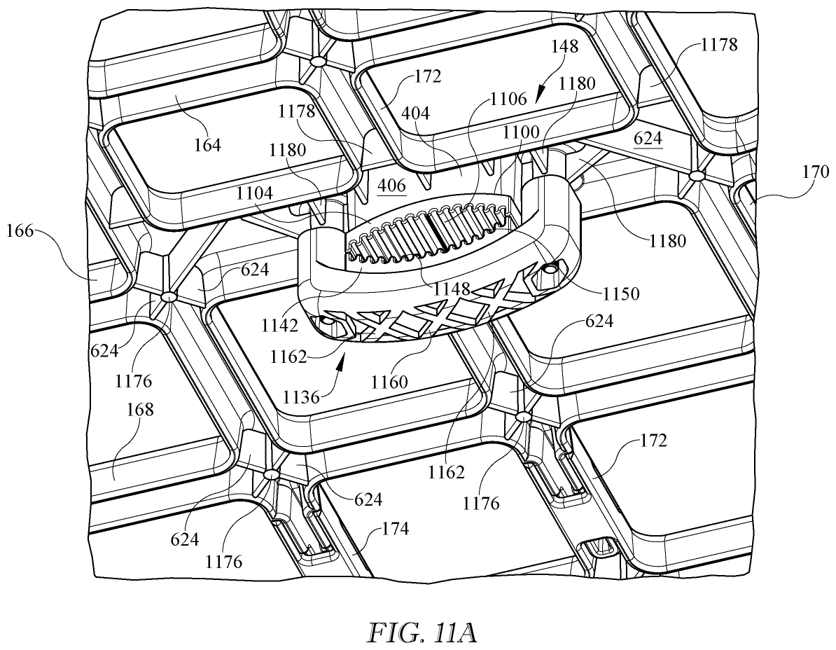

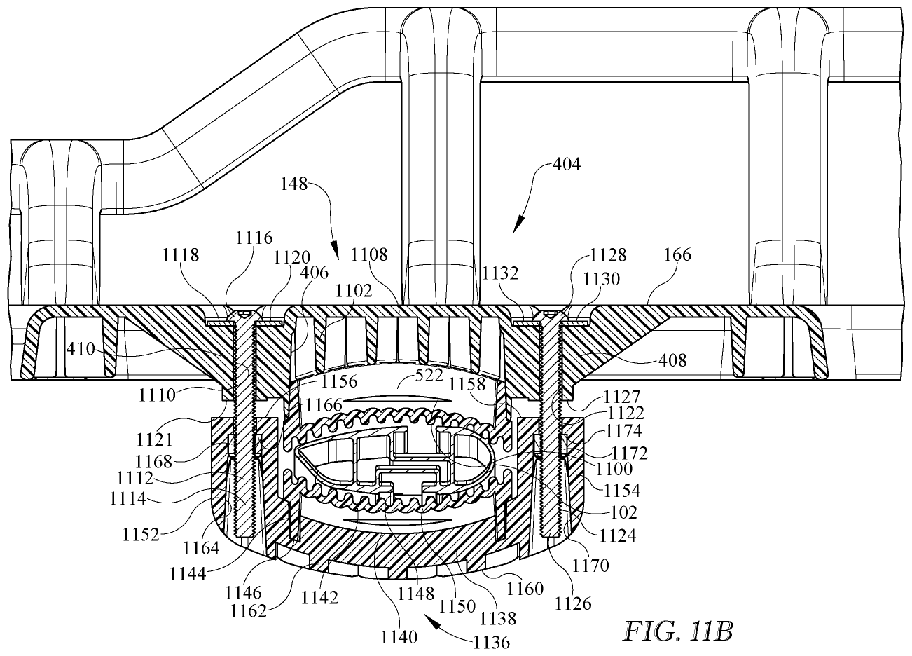

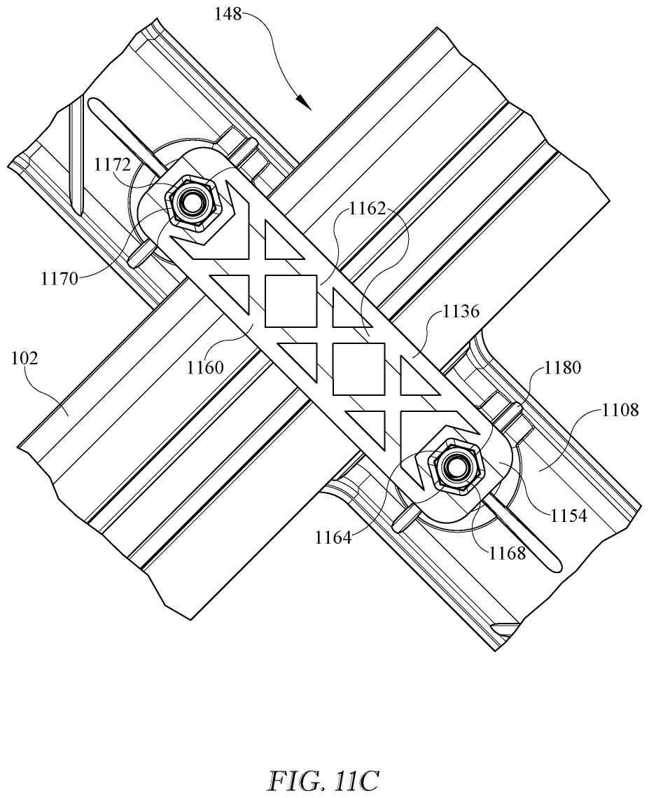

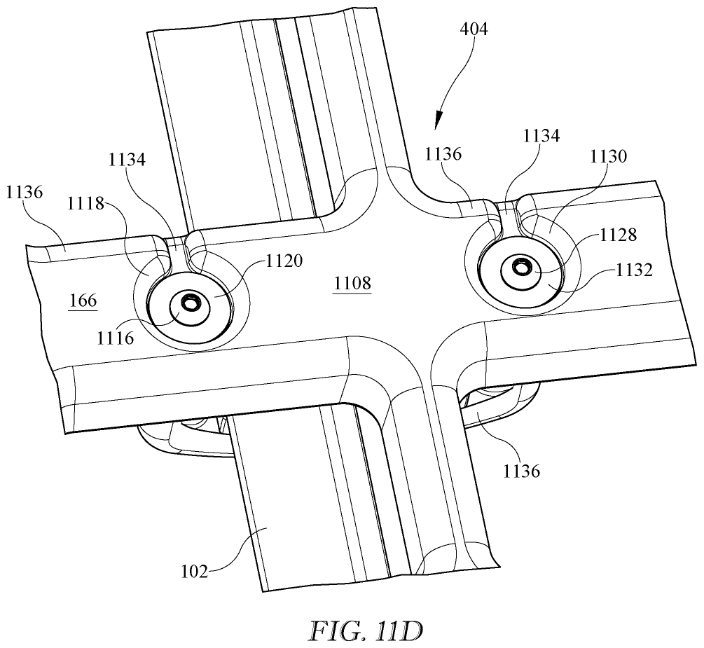

FIGS. 11A-11D are details of a representative crossbar mounting member 148. In FIG. 11A, the crossbar 102 is omitted for clarity. The other crossbar mounting members 146, 150, 152 described for this embodiment can be similar in construction. Crossbar mounting member 148 includes an upper component 404 that is integrally molded as an enlargement of intermediate longitudinal beam portion 166. Upper component 404 is formed between the intersections of longitudinal beam portion 166 with transverse beam portion 174 and transverse beam portion 170. Upper component 404 has a substantially downwardly hollow upper pad receptacle 406. The upper pad receptable 406 may have a downwardly concave lower margin 1100 that substantially follows the cross-sectional shape of the crossbar 102 to which mounting member 148 is affixed.

Crossbar 102 will often be teardrop-shaped in section (FIG. 11B). The shape of lower margin 1100 may be altered to match crossbars having different cross sections. Upper pad receptacle 406 may have therein a series of spaced-apart, downwardly extending fins 1102. Fins 1102 create more surface area for the distribution of compressive force of the soft pad 1104 when the cross beam 1136 is tightened. The upper pad 1104 is formed of a material softer and more elastic than upper pad receptacle 406, and may be molded of a thermoplastic elastomer (TPE). Upper pad 1104 may have a corrugated lower surface 1106 meant to better grip and distribute compressive force on crossbar 102.

In the section shown in FIG. 11B, upper pad 1104 appears hollow, but upper pad 1104 may have an array of fore-and-aft oriented, transversely spaced-apart walls (not shown) that are disposed in the pad receptable 522.

In this embodiment the upper pad receptacle 406 downwardly extends from, and is integrally molded with, a top web 1108 (FIGS. 11B and 11D) of the upper crossbar mounting member component 404. The upper pad receptacle 406 may define a prismatically rectangular inner volume and is disposed between the front bolt housing 408 and the rear bolt housing 410. The rear bolt housing 410 defines a rear bore 1110 that receives a shaft 1112 of a rear bolt 1114. A head 1116 of bolt 1114 is received in a rear depression 1118 in top web 1108, as is a washer 1120 through which shaft 1112 is inserted (FIG. 11D). The rear bolt housing 410 has a downwardly facing, flat lower surface 1121 (FIG. 11B).

Similarly, the front bolt housing 408 defines a front bore 1122 that receives a shaft 1124 of a front bolt 1126. The front bolt housing 408 terminates in a downwardly facing flat surface 1127. A head 1128 of front bolt 1126 is received in a front depression 1130 in top web 1108, as is a washer 1132 through which shaft 1124 is inserted. As seen in FIG. 11D, each depression 1118, 1130 has a channel 1134 to a side wall 1136 of the beam portion 166. The depressions 1118, 1130 face upward and will collect rain and water drips from whatever object(s) basket 100 is holding. The channels 1134 ensure that no water will stand in depressions 1118, 1130.

The other major component of crossbar mounting member 148 is a cross beam 1136. In use the cross beam 1136 is disposed below a crossbar 102, affixing the roof basket 100 to the crossbar 102 and thus to vehicle V. A lower pad receptacle 1138 of the cross beam 1136 may have an upper margin 1140 that is upwardly concave, so as to conform to a lower surface of the captured crossbar 102. In this embodiment the lower pad receptacle 1138 has mounted to it a lower pad 1142, which is softer and more elastic than the polymer compound used to mold cross beam 1136 and which may be molded of an elastomer such as TPE. The margin 1140 may have indentations 1144 to closely receive downwardly extending fins 1146 of the lower pad 1142 so as to better retain pad 1142. An upper surface 1148 of the lower pad 1142 is generally upwardly concave, so as to conform to the shape of the lower surface of crossbar 102. The upper surface 1148 may have corrugations 1150 in order to better conform to, grip, and spread the compressive force imposed on crossbar 102.

Cross beam 1136 further has an upwardly extending rear leg 1152 disposed to one side of the lower pad receptacle 1138, and an upwardly extending front leg 1154 disposed to the opposite side of the lower pad receptacle 1138. A flat upper surface 1156 of rear leg 1152 will always be spaced from lower bolt housing surface 1121 when the cross beam 1136 is bolted to the upper component 404. A flat upper surface 1158 of front leg 1154 will always be spaced from lower bolt housing surface 1127 when the cross beam 1136 is bolted to the upper component 404. This spacing forces all contact to be between pads 1104, 1142 and crossbar 102.

The cross beam 1136 has a lower surface 1160 formed as a series of substantially vertical, intersecting plates 1162. This produces a stronger cross beam 1136 while still being easily moldable out of a polymer compound. A substantially prismatic rear cavity 1164 upwardly extends from lower surface 1160 to a ceiling 1166. But rear cavity 1164 is not exactly prismatic, as it does not have a constant cross sectional area but rather one that decreases as one proceeds upward. This eases the insertion of a nut 1168 and its threading onto bolt shaft 1112. The cross-sectional shape of the cavity 1164 should match the cross-sectional shape of the nut 1168; in this illustrated embodiment, both are hexagonal. Therefore, as bolt 1114 is turned clockwise on its axis, the nut 1168 will be drawn upward into cavity 1164 until it is seated on ceiling 1166. Cross beam 1136 will not be seated on surfaces 1121, 1127 when the roof basket is being mounted to the crossbars, regardless of the cross-sectional size of the crossbar.

Front leg 1154 has a corresponding front cavity 1170 that can be similar in structure to rear cavity 1164. As bolt 1126 is rotated clockwise, a nut 1172 will be drawn upward on bolt shaft 1124 until nut 1172 is seated on a cavity ceiling 1174. When legs 1152 and 1154 are firmly attached to crossbar mounting member upper component 404, the crossbar mounting member 148 will be gripping the crossbar 102 with compressive force.

Also seen in FIG. 11A are various reinforcing webs of the otherwise hollow, downward facing u-shaped channels forming the roof basket 100. The reinforcing webs are in various vertical planes and include webs 624 which form “X's” at each intersection of a longitudinal beam portion and a transverse beam portion. Webs 624 may meet at a downwardly extending, vertical center post 1176. The reinforcing webs may further include webs 1178 that span the beam channel and are disposed in perpendicular to the axis of the beam portion, and webs 1180 that radiate from the bolt housings 408, 410.

Roof basket 100 may be modular, and in the illustrated embodiment has four different configurations. A “small” configuration, using only corner portions 110-116, is seen in FIGS. 1A and 1B. A “long” configuration 1200 is illustrated in FIG. 12. In configuration 1200, rear corner portions 110 and 114 are directly fastened together, as are forward corner portions 112 and 116. But left rear corner portion 110 is fastened to left forward corner portion 112 by means of a left longitudinal expansion portion 1202, and right rear corner portion 114 is fastened to right forward corner portion 116 by means of a right longitudinal expansion portion 1204. Expansion portions 1202 and 1204 are also connected to each other. The result is a roof basket 100 that is longer than the “small” configuration shown in FIGS. 1A and 1B. In an alternative embodiment, expansion portions 1202 and 1204 may be replaced with a single integral longitudinal expansion portion (not shown).

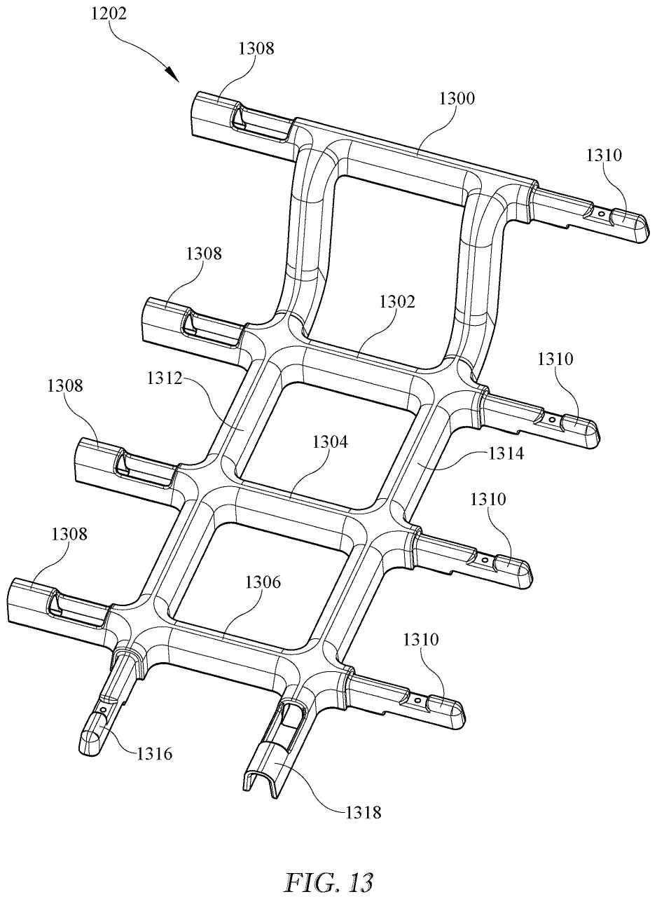

A representative longitudinal expansion portion 1202 is shown in FIG. 13. By an adroit choice of female and male free ends of the various beam portions making up expansion portion 1202, expansion portion 1204 can be identical to expansion portion 1202. Expansion portion 1202 has four longitudinal beam portions 1300, 1302, 1304, 1306, each having two free ends. In each case, a rear free end of beam portions 1300, 1302, 1304 and 1306 is a female free end 1308. In each case, a forward free end of beam portions 1300, 1302, 1304 and 1306 is a male free end 1310. Female free ends 1308 are respectively connectable to the male free ends 402 of longitudinal beam portions 162, 164, 166 and 170 (FIGS. 4A and 4B), while male free ends 1310 are respectively connectable to female free ends 500 on the longitudinal beam portions 504, 514, 516 and 518 of left front corner portion 112 (FIGS. 5A and 5B).

Expansion portion 1202 has two transverse beam portions 1312 and 1314 that intersect and are integrally molded with the longitudinal beam portions 1300-1306. Each has a single free end. Beam portion 1312 has a male free end 1316. Beam portion 1314 has a female free end 1318. The male and female free ends 1316, 1318 are specified to be different from each other so that they can be connected to respective female and male free ends of the identical expansion portion 1204. Expansion portion 1204 is oriented such that its longitudinal male ends extend rearwardly, and its longitudinal female ends extend forwardly. Therefore, the longitudinal male ends of expansion portion 1204 are connectable to respective longitudinal female free ends of right rear corner portion 114, while the longitudinal female ends of expansion portion 1204 are connectable to respective male free ends of right front corner portion 116.

All expansion portions are injection molded as integral components, and all are composed of beam portions formed as downward-facing, u-shaped channels similar to those shown in FIG. 10.

In a further, “extra long” configuration (not shown), a further pair of longitudinal expansion portions would be used to further extend the length of the roof basket. Four such longitudinal expansion portions 1202, 1204 would be interposed between the front corner portions 112, 116 on the one hand and the rear corner portions 110, 114 on the other. Further pairs of longitudinal expansion portions could extend the length of the roof basket even further.

FIG. 14 illustrates a “wide” configuration 1400 of the roof basket 100. Corner portions 110-116 are used as before. However, right rear corner portion 114 is joined directly to right front corner portion 116, and left rear corner portion 110 is joined directly to left front corner portion 112. This configuration employs a pair of transverse expansion portions 1402 and 1404. In an alternative embodiment, a single transverse expansion portion may take the place of portions 1402 and 1404. In the illustrated embodiment, front transverse expansion portion 1402 connects left front corner portion 112 to right front corner portion 116, and rear transverse expansion portion 1404 connects left rear corner portion 110 to right rear corner portion 114. The transverse expansion portions 1402 and 1404 further are connected to each other. The use of transverse expansion portions creates a roof basket that is wider than the “small” configuration seen in FIGS. 1A and 1B. An expanded wind deflector, as seen in FIGS. 2D and 2E, could be used with this configuration, or alternatively a single-piece wind deflector with a width that fits to the width of wide configuration 1400.

A representative transverse expansion portion 1402 is shown in detail in FIG. 15. Transverse portion 1404 may be identical to it, but in use will have an orientation 180 degrees from that of expansion portion 1402. The transverse portion 1402 has five transverse beam portions 1406, 1408, 1410, 1412 and 1414. Beam portions 1406-1414 each have two free ends, one of which is a male free end 1416 and one of which is a female free end 1418. The transverse male free ends 1416 of transverse expansion portion 1402 are fastenable to respective transverse female free ends 500 of left front transverse beam portions 502, 506, 508, 510 and 512 (FIGS. 5A and 5B). The transverse female free ends 1418 are respectively connectable to transverse male ends 402 of right front transverse beam portions 160, 170, 172, 174 and 176 (FIGS. 4A and 4B).

In like manner, transverse male free ends of transverse expansion portion 1404 are connectable to respective transverse female free ends of the transverse beam portions of right rear corner portion 114, while transverse female free ends of transverse expansion portion 1404 are connectable to respective male free ends of the transverse beam portions of left rear corner portion 110.

The transverse expansion portion 1402 has two longitudinal beam portions 1420 and 1422, and each of these has a single free end. Free end 1424 of beam portion 1420 is female. Free end 1426 of beam portion 1422 is male. Female and male free ends 1424, 1426 intentionally are different from each other, such that they are respectively connectable to male and female free ends of transverse expansion portion 1404, which can be identical to transverse expansion portion 1402 but which in use will have an orientation 180 degrees different from the orientation of transverse expansion portion 1402.

For an “extra wide” roof basket configuration (not shown), one or more additional pairs of transverse expansion portions 1402, 1404 would be interposed between left corner portions 110, 112 on the one hand, and right corner portions 114, 116 on the other. For each additional pair of transverse expansion portions, and additional air dam center portion 248 should also be used.

FIG. 16 illustrates a “max” configuration 1600 of the modular roof basket, in which both the length and width of the roof basket has been increased from the “small” configuration seen in FIGS. 1A and 1B. “Max” configuration 1600 uses both a pair of longitudinal expansion portions 1202 and 1204, and a pair of transverse expansion portions 1402 and 1404. As in the “long” configuration (FIG. 12), longitudinal expansion portion 1202 connects left front corner portion 112 to left rear corner portion 110, and longitudinal expansion portion 1204 connects together front right corner portion 116 to rear right corner portion 114. As in the “wide” configuration (FIG. 14), transverse expansion portion 1402 connects together left front corner portion 112 to right front corner portion 116, and transverse expansion portion 1404 connects together left rear corner portion 110 to right rear corner portion 114. But none of the expansion portions 1202, 1204, 1402, 1404 is directly connected to any other longitudinal or transverse expansion portion.

In one embodiment, a “hole” in the middle of the roof basket could be accepted and the various expansion portions left unconnected to each other. But in the illustrated embodiment, a center expansion portion 1602 is used to connect together the four other expansion portions to enhance the integrity of “max” configuration 1600.

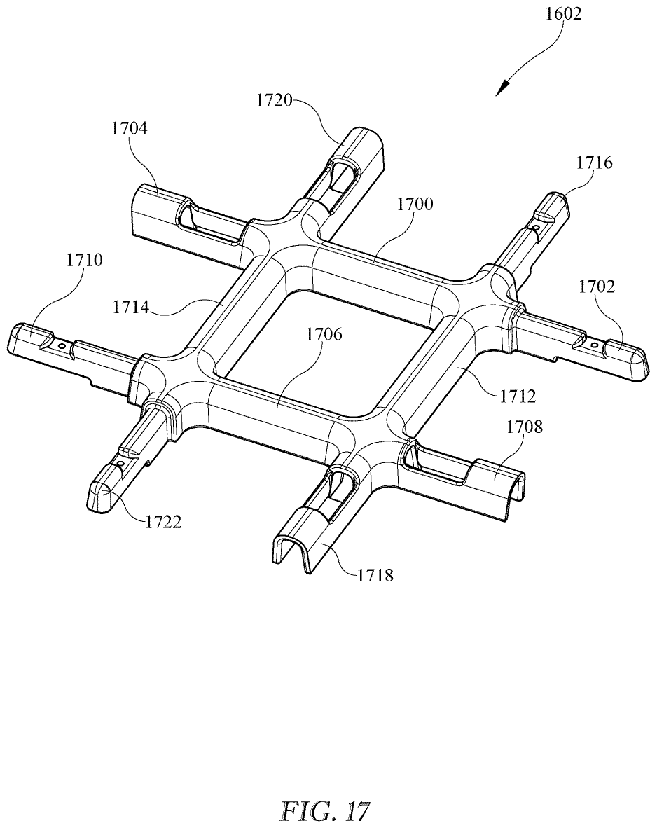

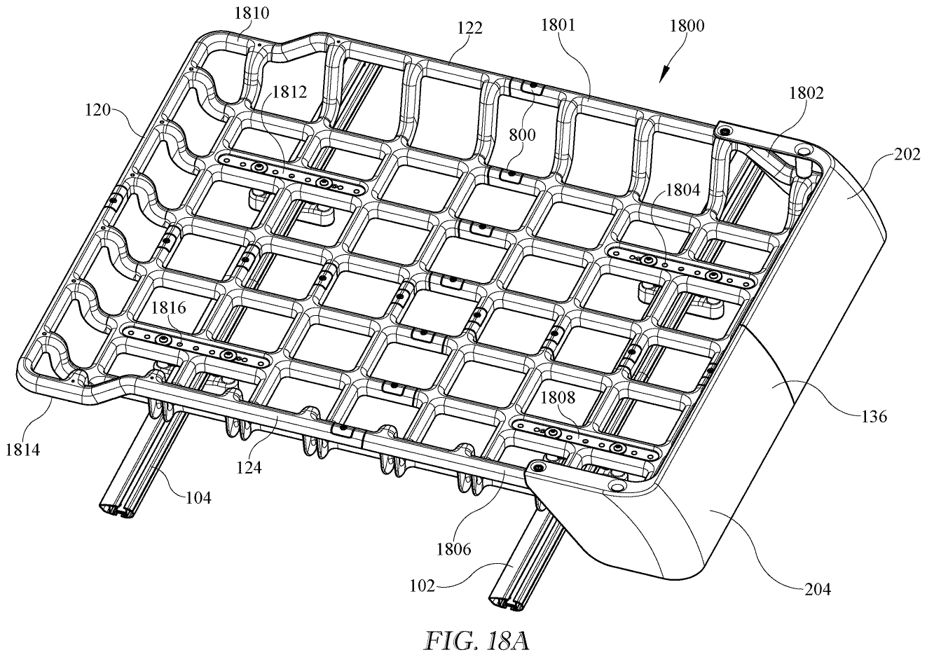

As seen in FIG. 17, the center expansion portion 1602 has a longitudinal beam portion 1700 with a forward male free end 1702 and a rearward female free end 1704. A second longitudinal beam portion 1706, spaced from and disposed in parallel to beam portion 1702, has a forward female free end 1708 and a rearward male free end 1710. Intersecting and integrally molded with the longitudinal beam portions 1700, 1706 are transverse beam portions 1712 and 1714, which are spaced from and parallel to each other. Beam portion 1712 has a left free male end 1716 and a right free female end 1718. Beam portion 1714 has a left free female end 1720 and a right free male end 1722.

In the “max” configuration 1600, female and male free ends 1720, 1716 are respectively connected to transverse male and female free ends 1316, 1318 of longitudinal expansion portion 1202 (FIG. 13). Male and female transverse free ends 1718, 1722 are connected to transverse female and male free ends of longitudinal expansion portion 1204. Male and female longitudinal free ends 1702, 1708 are respectively connected to female and male longitudinal free ends 1424, 1426 of transverse expansion portion 1402 (FIG. 15). And female and male longitudinal free ends 1704, 1710 are respectively connected to male and female longitudinal free ends of transverse expansion portion 1404.

Various “supermax” configurations (not shown) could be made, with sets of three expansion portions 1202, 1602, 1204 for each additional increment in length, and sets of three expansion portions 1402, 1602, 1404 for each additional increment in width. Fashioning a “supermax” configuration that is one increment both longer and wider than the one shown in FIG. 16 would require four center expansion portions 1602.

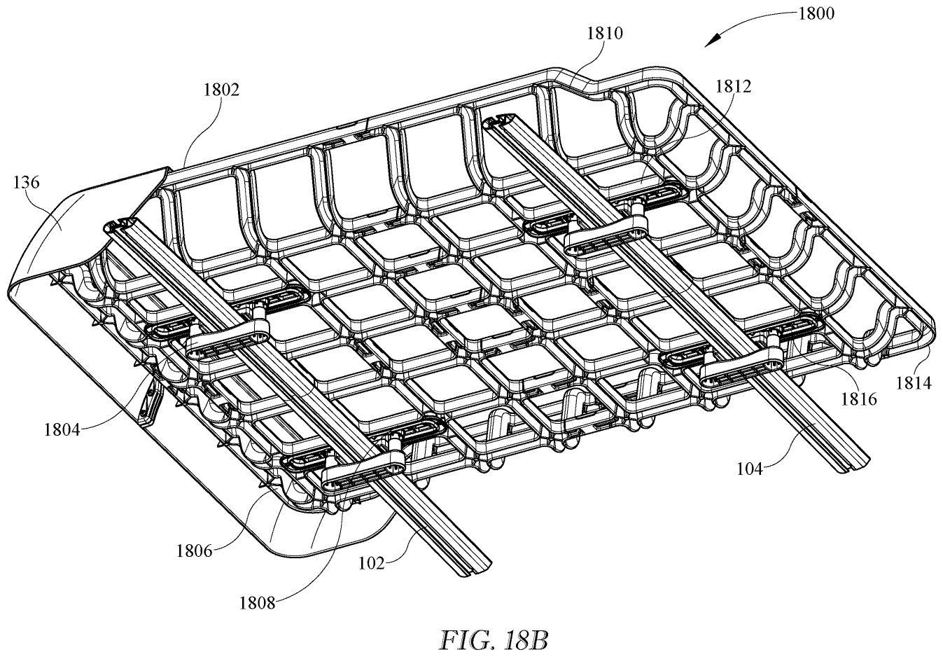

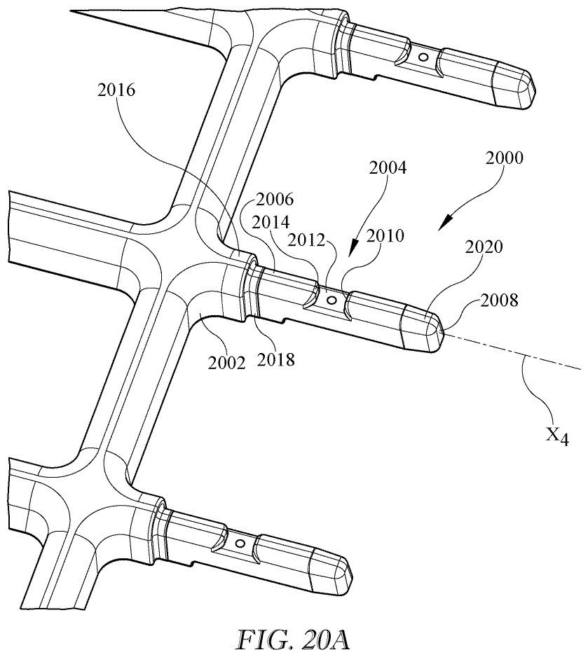

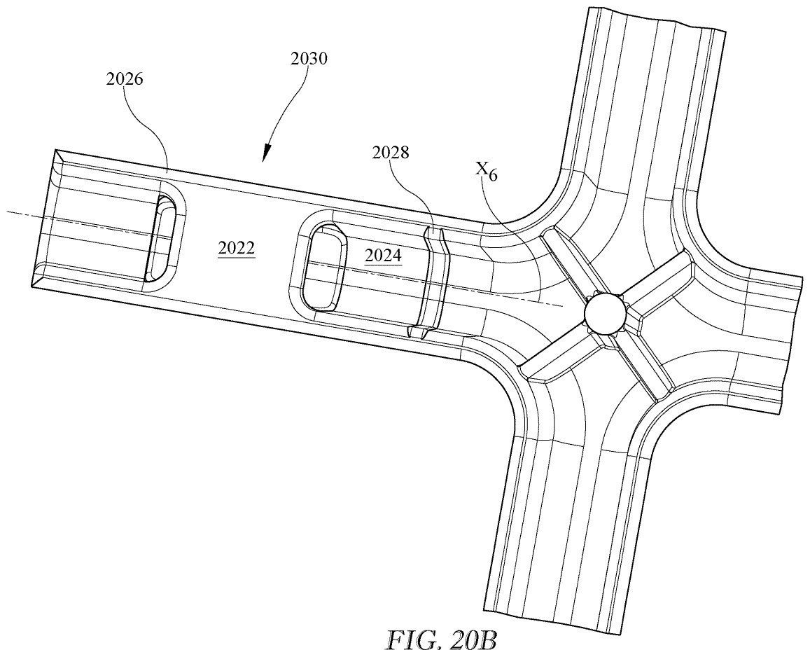

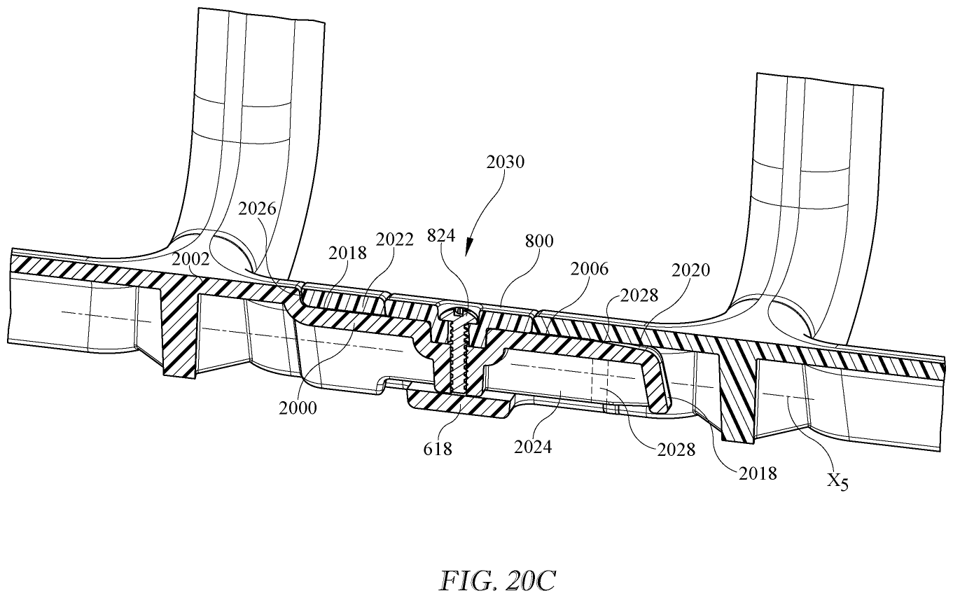

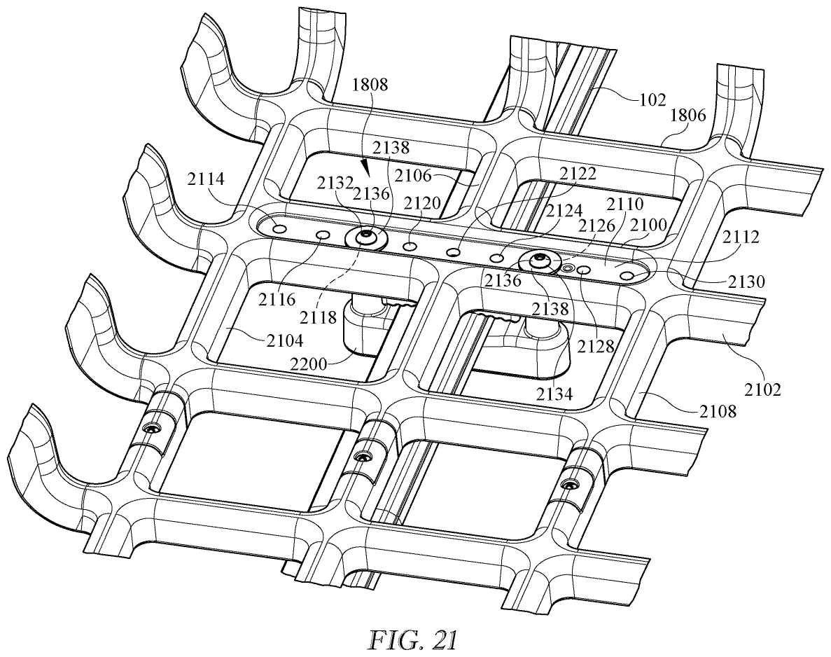

The embodiment shown in FIGS. 18A and 18B has been modified in two principal ways from the embodiment introduced in FIGS. 1A and 1B. These two principal modifications are changes in the shape of the male and female ends, as illustrated in FIGS. 20A-20C, and the replacement of the upper components 404 of the crossbar mounting members 146, 148, 150 and 152 with position-adjustable clamp sleds, as illustrated in FIGS. 21, 22, 23A-B, 24, 25A-B, 26A-B and 27A-D. Apart from these modifications, the roof basket 1800 (FIGS. 18A and 18B) is similar to roof basket 100 (FIGS. 1A and 1B), is similarly modular, and may be expanded by longitudinal, transverse and/or central expansion portions in the same way. The wind deflector 136 also is modular and may be transversely expanded as needed.

As seen in FIG. 18A, a carrier or roof basket body 1801 includes a left front corner portion 1802 that is mounted on crossbar 102 by a left front crossbar mounting member 1804. A right front corner portion 1806 of body 1801 is connected to crossbar 102 by a right front crossbar mounting member 1808 that is spaced from crossbar mounting member 1804 in a transverse direction. A left rear corner portion 1810 of body 1801 is connected to crossbar 104 by a left rear crossbar mounting member 1812 that is spaced from crossbar mounting member 1804 in a longitudinal direction. A right rear corner portion 1814 of body 1801 is connected to crossbar 104 by a right rear crossbar mounting member 1816, which is spaced from crossbar mounting member 1804 in both longitudinal and transverse directions. The portions 1802, 1806, 1810 and 1814 are composed of transverse and longitudinal beam portions, as before, and these beam portions each have a free end that is either male or female. In this embodiment, the body 1801 is assembled from portions 1802, 1806, 1810 and 1814 by connecting together several complementary pairs of the male and female free ends.

A representative male free end 2000 is shown in FIGS. 20A and 20C. Male free end 2000 terminates a representative beam portion 2002, which can be either longitudinal or transverse. As before, the beam portion 2002 is formed as a downwardly open channel and will conform to a beam axis X₅ (FIG. 20C). Male free end axis X₄ will conform to axis X₅ once the male free end 2000 has been inserted into a corresponding female free end (described below) to assume a predetermined connection position.

As before, a mortise 2004 downwardly extends from an upwardly convex outer surface 2006 of the male free end 2000. The mortise 2004 is spaced in a proximal direction (in this FIGURE, leftward) from a male free end distal surface 2008. Mortise 2004 may take the form of a slot open toward the top and is defined by a distal end wall 2010, a substantially horizontal flat bottom surface 2012 aligned with axis X₄, and a proximal end wall 2014 that is spaced from the distal end wall 2010 by the bottom surface 2012. Proximal and distal end walls 2014 and 2010 may have a nonzero draft relative to a plane perpendicular to axis X₄, such that they will be slanted downwardly and toward each other.

The general outer surface 2006 of male free end 2000 is inwardly stepped from a general outer surface 2016 of the beam portion 2002. However, general outer surface 2006 is joined to general outer surface 2016 by an intermediate stepped surface or band 2018. At any particular orthogonal radius from axis X₄, the radial distance to stepped surface 2018 will be slightly greater than the corresponding distance to surface 2006 and will be less than the corresponding distance to beam portion outer surface 2016.

As one proceeds distally along male free end 2000 from the stepped surface 2018, the general outer surface 2006 of the male free end remains constant in its displacement from axis X₄, with the exception of mortise 2004. That is the case until distal end 2008 begins to be approached. Then, surface 2006 is replaced with a distally tapering surface 2020 that begins to taper toward axis X₄. The tapering occurs in both vertical and transverse directions.

Corresponding female free end 2022 (FIG. 20B) is in general similar to the female free ends 500 in the first embodiment. An upwardly convex general inner surface 2024 of the female free end 2022 stays at a constant distance relative to axis X₆ until its distal end 2026, with the exception of a band 2028 spaced proximally from a female end key hole 2030. The surface of band 2028 is displaced radially inwardly from general inner surface 2024 and toward axis X₆. Band 2028 otherwise generally follows the contour of general inner surface 2024.

A male free end 2000 is shown assembled to a female free end 2022 in FIG. 20C. As before, this is done with a key 800, whose shape is same as the keys 800 used in the first embodiment. FIG. 20C shows male free end 2000 in a fully inserted connection position relative to female free end 2022. Prior to being fully inserted, the general outer surface 2006 of male free end 2000 will be slightly inwardly spaced from female free end general inner surface 2024; the fit between surface 2006 and surface 2024 intentionally is loose. Male free end surface 2020 is tapered to ease the assembly of the male end 2000 to the female free end 2022. This ease in assembly is useful because the end user will have to assemble as many as five or more male free ends 2000 to a corresponding five or more female free ends 2022 at the same time, and the tapering and loose fit create a tolerance for a certain degree of misalignment of one basket portion as it is being assembled to another basket portion.

However, this looseness disappears once the male free end 2000 is inserted all the way into the female free end 2022, so as to assume a predetermined connection position. Surface 2024, near female distal end 2026, fits snugly to male stepped surface 2018. Male free end surface 2006, near the beginning of tapering surface 2020, will fit snugly to female band 2028. This tighter fit correctly aligns the male free end 2000 to the female free end 2022 such that both such ends conform to axis X₅. The increased tightness in fit is perceptible to the assembler of body 1801, who will then know that the male free ends 2000 have been correctly and fully inserted into the female free ends 2022.

A representative crossbar mounting member 1808 is shown in FIGS. 21-27D. Crossbar mounting members 1804, 1812 and 1816 are similar in structure. A thickened portion 2100 of a longitudinal beam 2102 extends from a forward transverse beam 2104, through an intersection with a transverse beam 2106, and rearwardly until transverse beam 2108. While crossbar mounting member 1808 is shown being used to mount a modular corner portion 1806 to a crossbar 102, it may more generally be used to mount a carrier body of any sort to a crossbar, whether the body is made up of modular portions of a basket, is an integral basket, or is a carrier of another shape.

The transversely thickened portion 2100 has an upper surface 2110 with a longitudinally elongated depression 2112. A plurality of longitudinally spaced-apart, vertically aligned bolt holes 2114-2130, in this embodiment nine such bolt holes, have upper ends that open onto the depression 2112. A first bolt 2132 is inserted into a selected one of these bolt holes, in this FIGURE bolt hole 2118. A second bolt 2134 is inserted into another one of the bolt holes, in this FIGURE bolt hole 2126, and in this embodiment four bolt holes removed from the bolt hole receiving first bolt 2132. In this embodiment, the selected bolt holes 2118 and 2126 are spaced from each other by a plurality of unselected bolt holes, in this instance bolt holes 2120, 2122 and 2124. The first and second bolts 2132 and 2134 may have rounded heads 2136 and may be inserted through washers 2138, and the depth of depression 2112 is specified so as to accommodate the height of the washers 2138 and the bolt heads 2136.

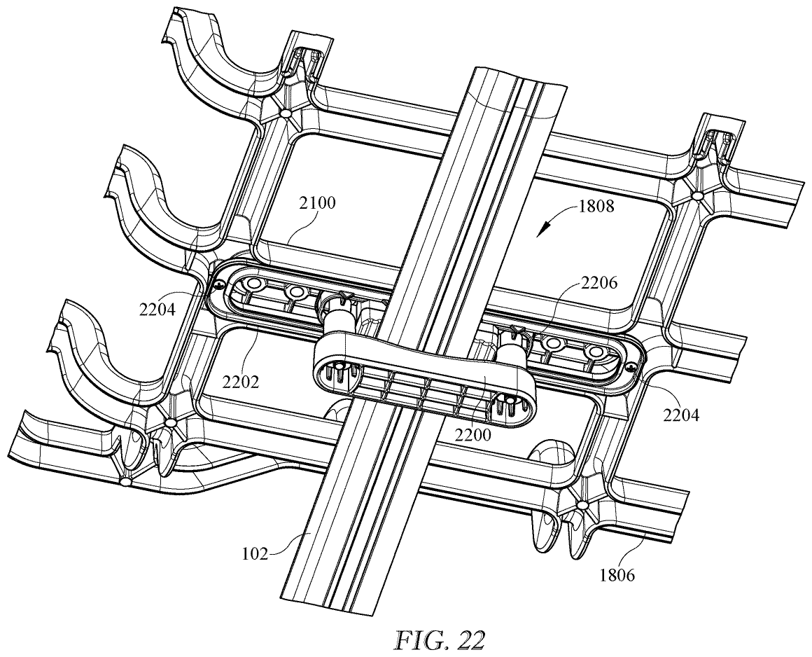

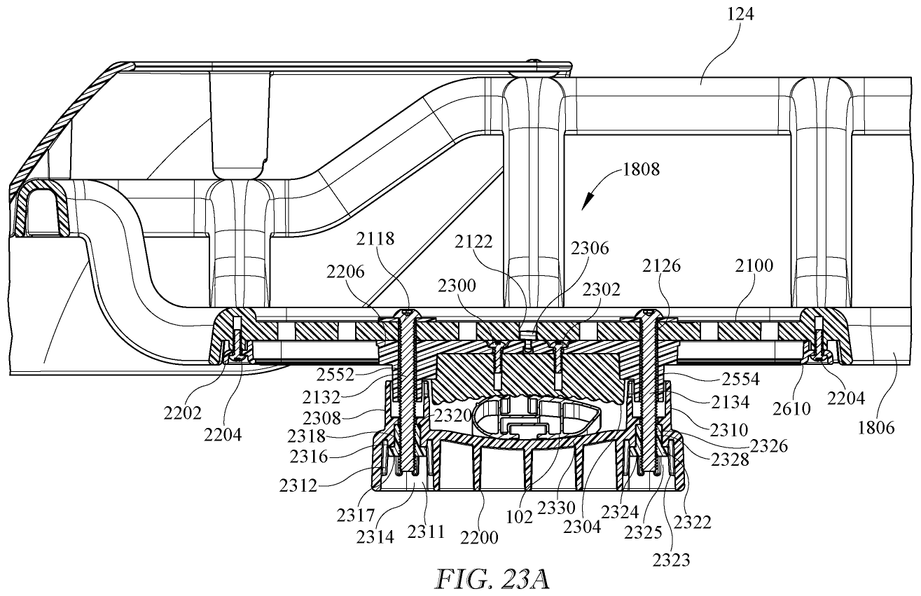

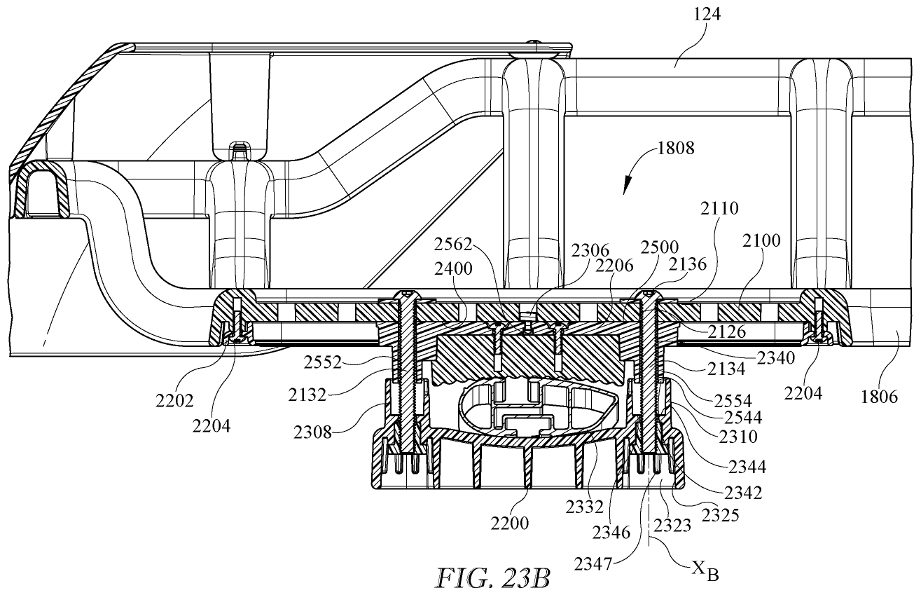

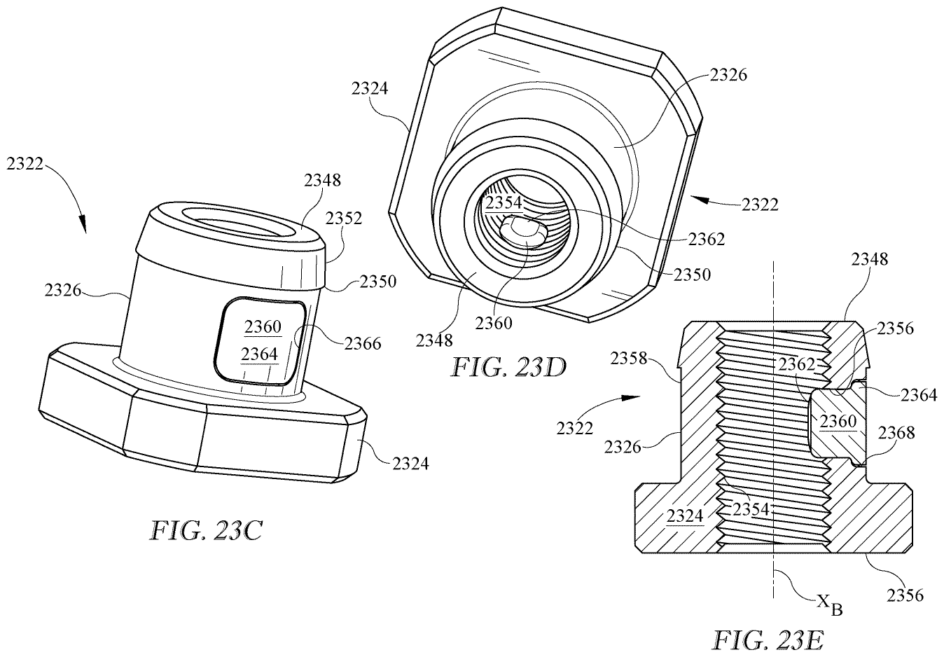

As seen in FIG. 22, the crossbar mounting member 1808 includes a cross beam 2200, somewhat similar to cross beam 1136 of the first embodiment. The cross beam 2200 is placed underneath the crossbar 102 and is bolted to basket portion 1806 by means of the front and rear bolts 2132 and 2134 (FIGS. 21 and 23). In this manner, the basket portion 1806 is mounted to the crossbar 102 and thus to vehicle V. Also seen in FIG. 22 is a sled rail or retainer 2202 that may be affixed to a lower surface of thickened portion 2100 as by screws 2204. The sled rail 2202 in turn acts to house a sliding clamp sled 2206 that, as will be explained, is longitudinally slidable among several positions along the thickened portion 2100.

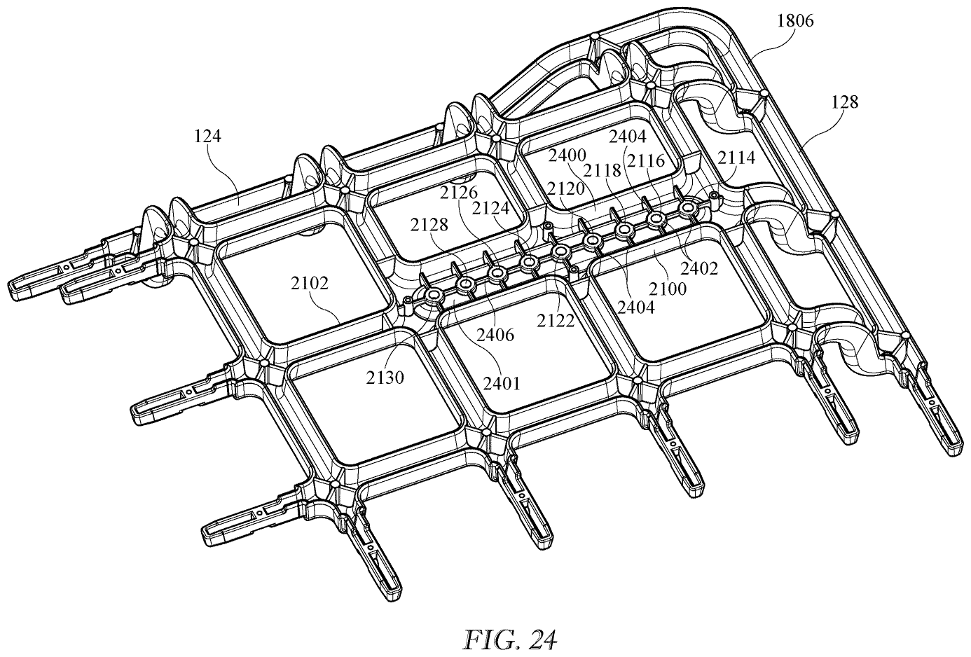

As seen in FIG. 24, the thickened portion 2100 of beam portion 2102 has, as its lower surface, a clamp sled attachment surface 2400 that takes the general form of a downwardly open, elongated cavity. But attachment surface 2400 is corrugated rather than smooth. Each of the regularly spaced bolt holes 2114-2130 opens onto lower surface 2400. Each of the bolt holes 2114-2130 is surrounded by an annulus or cylindrical boss 2402 that downwardly extends from a general lower surface 2401. Attachment surface 2400 further has, for each of the bolt holes 2114-2130, a transversely and vertically oriented rib 2404 that is positioned to be in transverse alignment with a respective bolt hole, and to be regularly and longitudinally spaced from the other ribs 2404. Each rib 2404 downwardly extends from the general surface 2401. There is further a downwardly depending, longitudinally oriented vertical rib 2406 that is aligned to each of the bolt holes 2114-2130.

The ribs 2404 and the bosses 2402 create a pattern of repeating units. In the illustrated embodiment, each annulus 2402, and an associated pair of ribs 2404 extending transversely from such annulus 2402, creates a single unit in this repeating pattern. In the illustrated embodiment, this unit is repeated nine times. In other embodiments (not shown), attachment surface 2400 may be corrugated instead with other repeating patterns of downwardly extending topographical features, such as ribs formed on an angle to the beam axis, wavy ribs, bolt hole reinforcements that are other than annular, or other repeating elements.

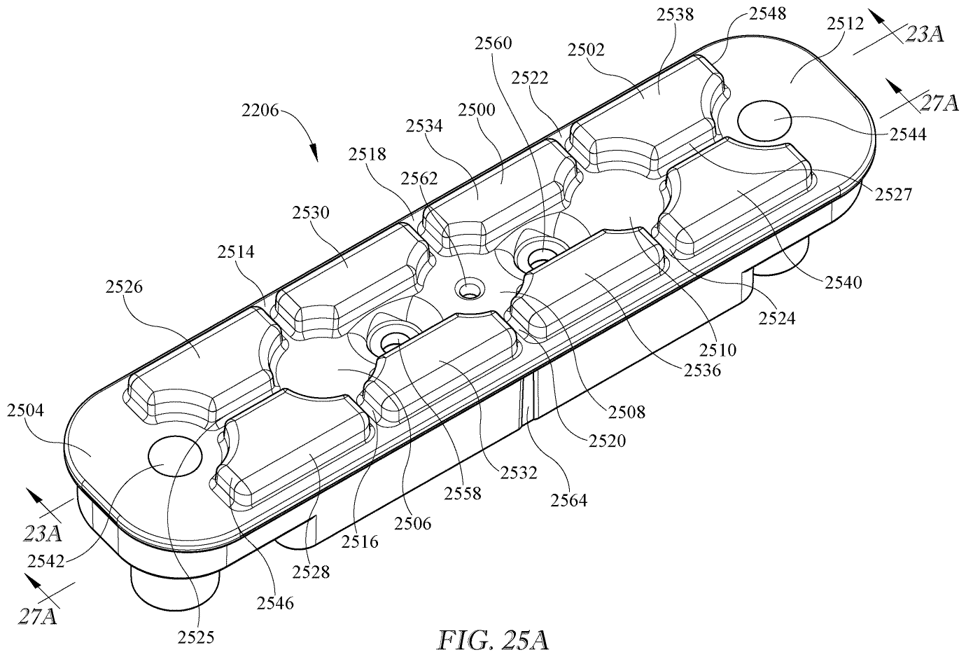

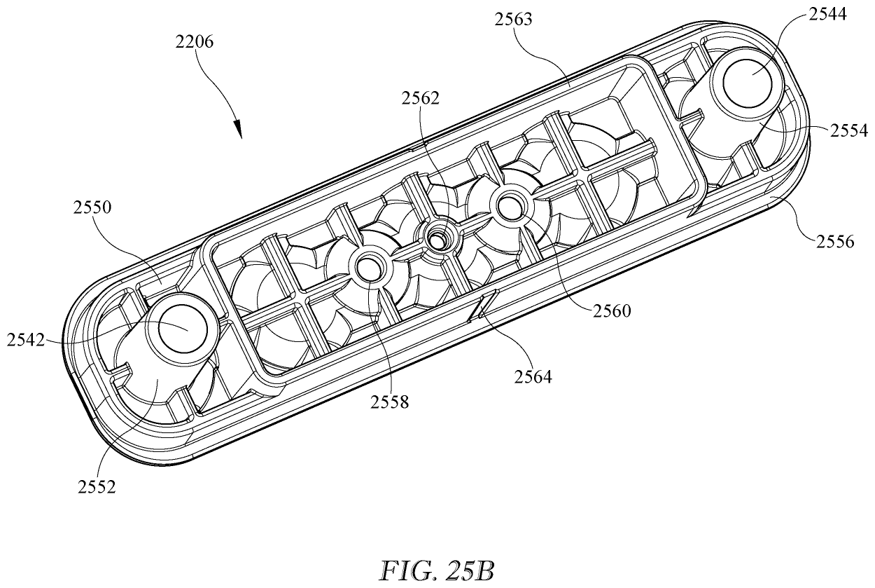

An upper surface 2500 of the clamp sled 2206 is seen in FIG. 25A. The top surface 2500 has a general top surface 2502 from which downwardly extend a plurality of circular or partly circular depressions or counterbores 2504. 2506, 2408, 2510 and 2512, transversely oriented grooves 2514, 2516, 2518, 2520, 2522 and 2524, and longitudinally oriented grooves 2525 and 2527. The depressions 2504-2512 and grooves 2514-2524 and 2525 and 2527 cut up the general top surface 2502 into eight mesas 2526, 2528, 2530, 2532, 2534, 2536, 2538 and 2540.

A left bolt hole 2542 is centered on the circular portion of leftmost depression 2504. A right bolt hole 2544 is centered on the circular portion of rightmost depression 2512. Once the clamp sled is positioned in a selected clamping position (as described below), the first bolt 2132 is inserted through bolt hole 2542 and the second bolt 2134 is inserted through bolt hole 2544.

The circular or partially circular counterbores or depressions are regularly spaced apart from each other and similarly sized, and in this embodiment five of the circular bosses 2402 of attachment surface 2400 (FIG. 24) fit within respective ones of them. Leftmost depression 2504 has a transversely oriented straight wall 2546, while rightmost depression 2512 has a transversely oriented straight wall 2548. The vertical wall portions of transverse grooves 2514-2524, and walls 2546-2548, fit to the transverse ribs 2404 of the attachment surface 2400 (FIG. 24). The longitudinal grooves 2525 and 2527 receive portions of longitudinal rib 2406 of the attachment surface 2400. Where, in other embodiments, other corrugations in surface 2400 are used, mirror-image changes would be made in surface 2500.

In general, and when the clamp sled is engaging the attachment surface 2400 to assume one of a preselected number of clamping positions, the ribs and bosses of the attachment surface 2400 on the one hand, and the grooves, walls and counterbores of the clamp sled upper surface 2500 on the other, present walls that interfere with each other and prevent movement of the clamp sled 2206 relative to the clamp sled attachment surface 2400 in any transverse direction. These walls cause the clamp sled to index to one of a predetermined number of clamping positions. Because of the extensive surface area of these interfering walls, this physical resistance will be much greater than a longitudinal force required to shear bolts 2132 and 2134.

In FIG. 25B, it can be seen that a lower surface 2550 of the clamp sled 2206 includes a first downwardly extending cylindrical housing 2552 defining bolt hole 2542 and through which first bolt 2132 is inserted, and a second downwardly cylindrical housing 2554 defining bolt hole 2544 and through which second bolt 2134 will be inserted. A transversely extending and circumferential lip 2556 is used to retain the clamp sled 2206 by the clamp sled rail 2202. Screw holes 2558 and 2560 respectively receive screws 2300 and 2302 (FIG. 23A) which are used to attach a crossbar upper pad 2304 to the clamp sled 2206. The screw holes 2558 and 2560 (FIG. 25B) have counterbores or dishes on their upper ends to accommodate the heads of screws 2300 and 2302. Alternatively, push-in fasteners (not shown) can be used.

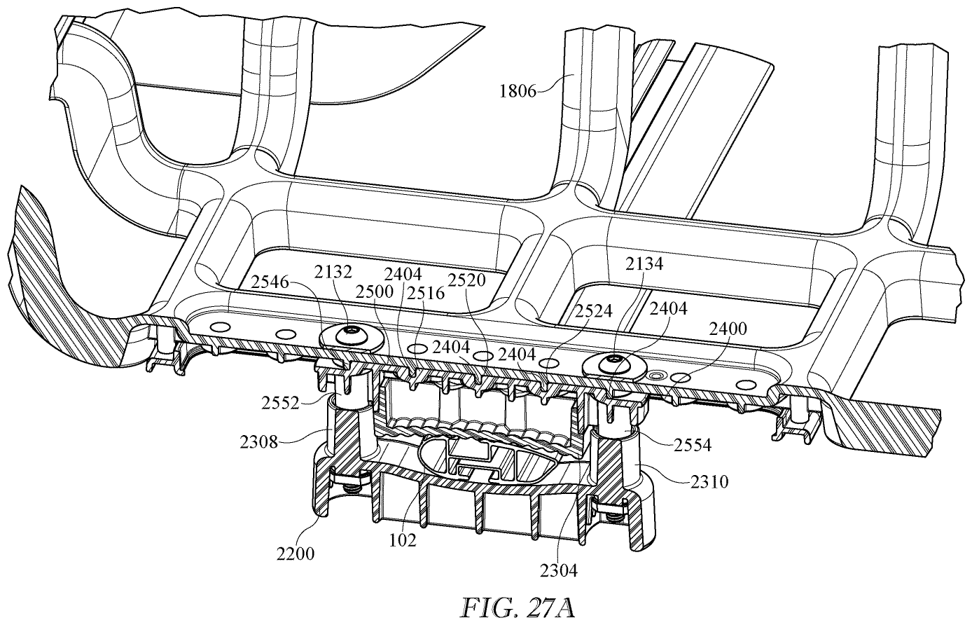

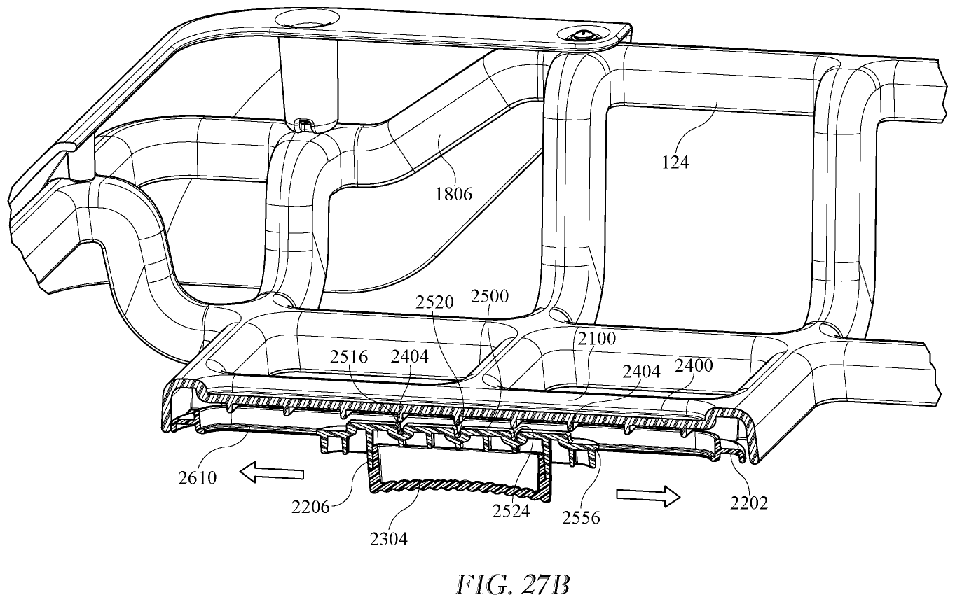

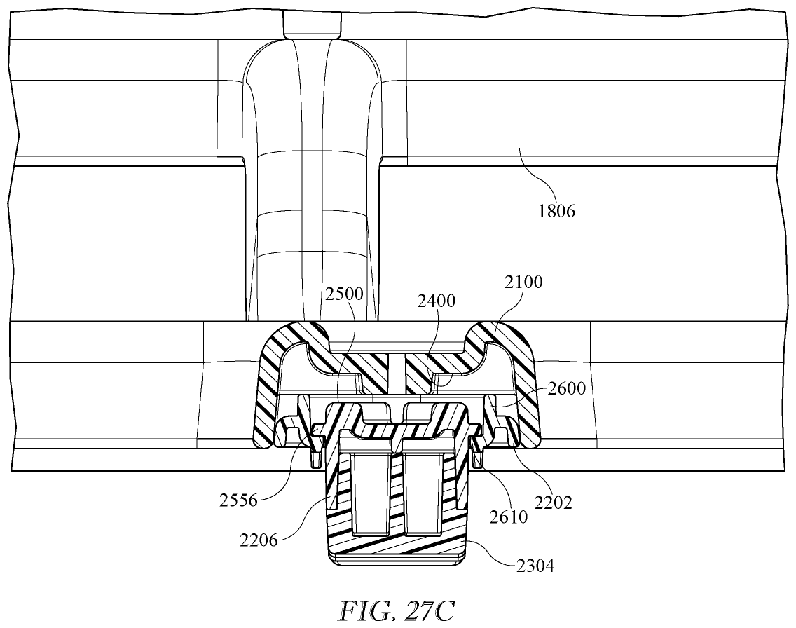

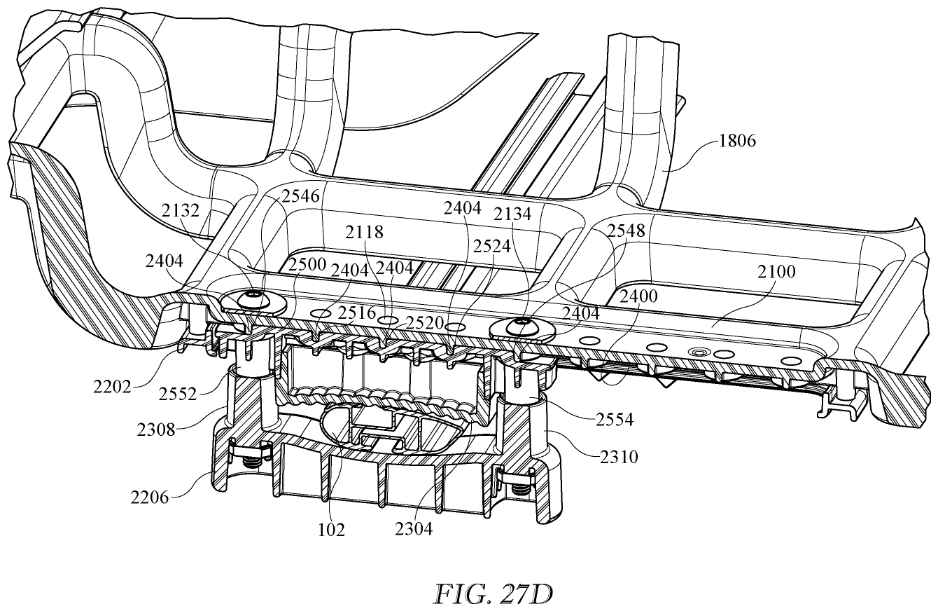

A central hole 2562 (FIGS. 25A and 25B) receives the shaft of an indicator post 2306 (FIG. 23A) that preferably is molded out of plastic in a color that contrasts with basket portion 1806. In the illustrated embodiment, the clamp sled 2206 may assume any of five longitudinal positions prior to being clamped to a crossbar. The head of the colored indicator post will fit into the bottom of one of the holes 2118, 2120, 2122, 2124 or 2126, and will be visible from above. In a first, forwardmost position of clamp sled 2206, the indicator post 2306 will appear in hole 2118. The first position is shown I FIG. 27D. In a second position, the indicator post 2306 will appear in hole 2120. In a third, middle position, the indicator post 2306 will appear in hole 2122. FIGS. 21, 22, 23A, 23B and 27A illustrate clamp sled 2206 in this third position. In a fourth position of clamp sled 2206, the indicator post 2306 will appear in hole 2124. In a fifth, rearmost position of clamp sled 2206, the position indicator 2306 will appear in hole 2126. In one embodiment (not shown), small numerals “1”, “2”, “3”, “4” and “5” may be engraved into the surface 2110 adjacent respective holes 2118, 2120, 2122, 2124 and 2126.

The position indicator 2306 thus indicates which of five positions the clamp sled 2206 is in. This tells the consumer where the other clamp sled clamping a particular cross bar should be positioned. The position of the left front clamp sled should match the position of the right front clamp sled, and the position of the left rear clamp sled should match the position of the right rear clamp sled.

A rectangularly prismatic pad retaining wall 2563 (FIG. 25B) downwardly extends from lip 2556. The upper pad 2304 (FIG. 23A) is fitted into this retaining wall 2564.

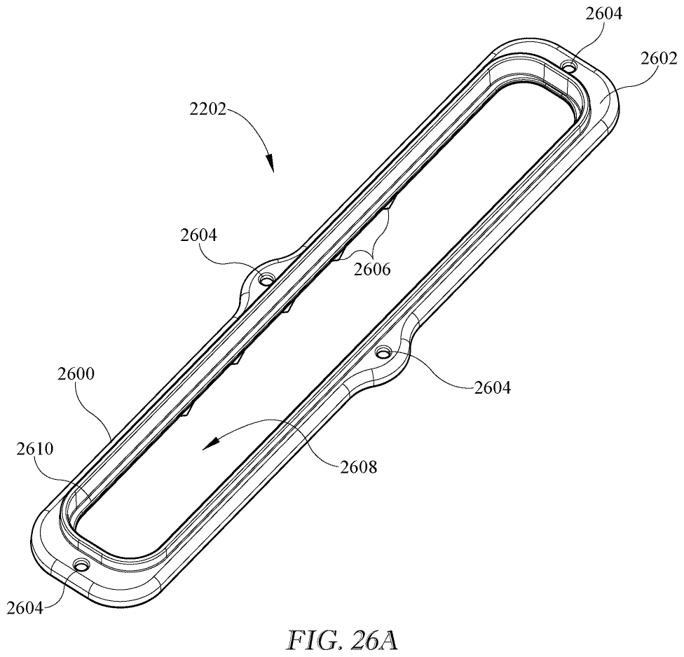

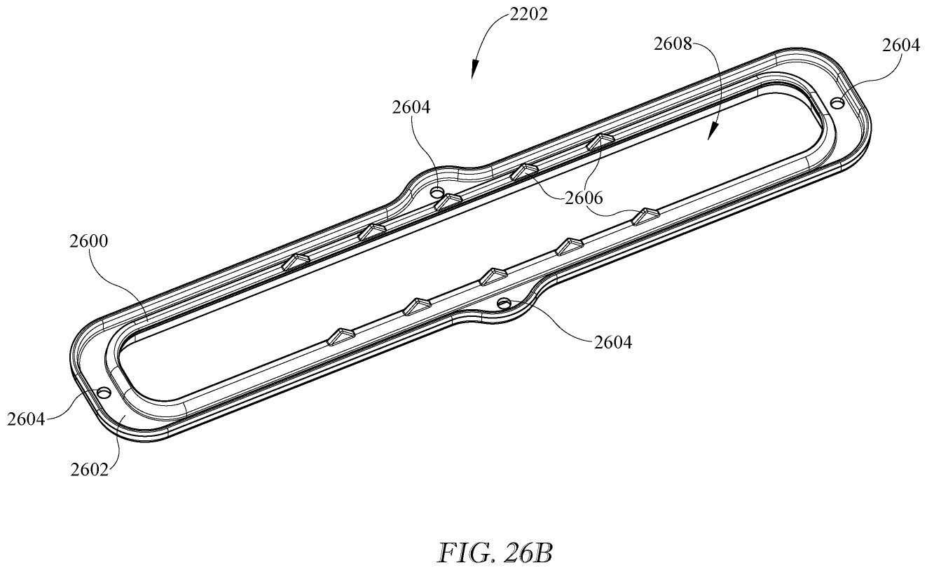

As seen in FIGS. 26A and 26B, the clamp sled rail or retainer 2202 has a central elongated ring 2600 that extends upwardly from a mounting flange 2602 and also extends downwardly from mounting flange 2602. The mounting flange 2602 is affixed to the basket portion 1806 as by screws 2204 (FIG. 23A) that are inserted through screw holes 2604. A bottom margin of ring 2600 may have a plurality of indicators 2606, one for each of the plurality of indexed clamping positions at which clamp sled 2206 may be affixed to the basket portion 1806. In the illustrated embodiment, these indicators 2606 are triangular. A vertical polished or indented stripe 2564 (FIG. 25A) may be formed at the longitudinal center of the clamping sled 2206 and will line up with one of these indicators 2606 to tell the user which of the multiple clamping positions has been selected, when viewed from the side. In alternative embodiments (not shown), the triangular indicators 2606 may be replaced or augmented by numbers, which would then match the numerical positions appearing on surface 2110.

The length of the clamp sled 2206 is much shorter than a length of ring 2600. The ring 2600 defines a slot 2608 within which the clamp sled may be longitudinally moved. A circumferential ledge 2610 (FIG. 26A) extends horizontally inwardly from a bottom margin of the ring 2600. When assembled to basket portion 1806, this ledge 2610 is disposed below clamp sled retaining lip 2556, retaining the clamp sled 2206 between the sled retainer 2202 and the basket portion 1806. Prior to being drawn up onto the attachment surface 2400, the clamp sled 2206 may slide along ledge 2610 to assume any of a number of different positions within slot 2608. When in any of these sliding positions, the upper surface 2500 of the clamp sled 2206 is entirely downwardly spaced from any part of the attachment surface 2400.

One of these sliding positions is shown in FIG. 27B, and a cross-sectional view is shown in FIG. 27C. Without bolts installed, the sled 2206 can drop down and slide to any of the possible positions. In this condition, the clamp sled 2206 has not yet been drawn up onto attachment surface 2400. The lip 2556 rides on sled retainer ledge 2610 and the clamp sled 2206 is freely translatable in a longitudinal direction to any position along slot 2608.

FIG. 23A is a cross-sectional view showing clamp sled 2206 at a central one of five clamping positions. The front clamp sled bolt housing 2552 is slidably received in a front bolt housing sleeve 2308 of the cross beam 2200. The rear clamp bolt housing 2554 is similarly slidably received in a rear bolt housing sleeve 2310 of the cross beam 2200. A front nut cavity 2311 defines, by the way of inwardly protruding fins 2312, a roughly square prismatic space 2314 into which a front nut 2316 is inserted. The nut 2316 has a bottom end with a substantially square flange 2317 that slides upwardly between fins 2312. A cylindrical portion 2318 of the nut 2316 axially upwardly extends from flange 2317 and fits within a cylindrical cavity 2320 in communication with the prismatic space 2314. In this embodiment, the nut 2316 does not move within the space 2314 as a function of the size of the crossbar 102 being clamped. Front bolt 2132 is threaded into nut 2316, and similarly, rear bolt 2134 is threaded into a rear cross beam nut 2322. The nut 2322 is similar to nut 2316. A bottom, substantially square flange 2324 of the nut 2322 is housed with a roughly square prismatic portion 2323 of a rear nut cavity 2325, while a top cylindrical portion 2326 of nut 2322 is housed within an upwardly extending cylindrical portion 2328 of the nut cavity 2325 that is in communication with the prismatic space 2323.

FIGS. 23C and 23D are perspective and axial sectional views of a representative crossbeam nut 2322, nut 2316 being similar. Nut 2322 can be part of a fastening system in which a component (in this case, cross beam 2200) may be attached to a body (in this case, crossbar mounting member 1808, itself a part of the roof basket 1800, in combination with clamp sled 2206). A bolt, such as bolt 2134, has a head 2136 (FIG. 23B) and a threaded shaft 2340. The bolt 2134 is made of a hard material such as stainless steel. The bolt head 2136 has a means by which torque may be applied to bolt 2134, such as an Allen wrench receptacle. The bolt head 2136 is disposed adjacent an upper surface of the body, such as the upper surface 2110 of the thickened portion 2100. The bolt shaft 2340 is disposed on a bolt axis X_{B} and is inserted through a bolt hole of the body, such as through a combination of bolt hole 2126 and rear clamp sled bolt hole 2544. The shaft 2340 protrudes from a lower surface of the body, such as lower surface 2342 of clamp sled 2206.

The bolt 2134 continues through an upper surface of the component to be attached, such as upper surface 2344 of the cross beam 2200. A cross beam bore 2346 communicates the cross beam upper surface 2344 to an upper surface 2346 of the rear nut cavity 2325. An upper portion 2328 of the nut cavity 2325 adjoins surface 2346 and is substantially cylindrical. A lower portion 2323 of the nut cavity 2325 extends downwardly from upper portion 2328 and may have a plurality of radially inwardly extending fins 2347 that will prevent the axial rotation of nut flange 2324.

As seen in FIG. 23C, the nut 2322 has an upper portion 2326 which may be substantially cylindrical and a lower portion or flange 2324, which is noncircular in axial cross section. The flange 2324 may be polygonal and more particularly may be substantially square, as shown. The noncircular sides of flange 2324 will abut against cavity fins 2347 to prevent the axial rotation of nut 2322.

The upper portion 2326 may include a barb 2350 with a downwardly and radially outwardly extending barb surface 2352. The body of the nut 2322 may be machined of brass or other metal, while the body of clamp sled 2200 may be molded of plastic. When the upper portion 2326 of the nut 2322 is inserted into the upper portion 2328 of the nut cavity 2325, the barb 2350 will bite into the surface of portion 2328. Considerably more force will be necessary to extract the nut 2322 from the cavity 2325 that what is necessary to insert nut 2322 into cavity 2325.

An internal cylindrical bore 2354 (FIGS. 23D and 23E) is threaded, is aligned on axis X_{B}, and extends from a top surface 2348 of nut 2322 to an opposed bottom surface 2356 thereof. The bore 2354 threadedly receives bolt shaft 2340. An insert hole 2356 is formed to extend from an external surface 2358 of upper portion 2326 to bore 2354. A nut insert 2360 is fitted into insert hole 2356. Nut insert 2360 may be held in place by the sidewall of cavity portion 2328. An inner end 2362 of the nut insert 2360 radially inwardly extends from the surface of bore 2354 toward axis X_{B}, so as to be in intentional interference with bolt shaft 2340. The nut insert 2360 is made of a material softer than bolt shaft 2340. Nut insert 2360 may be formed of a polymer such as nylon. When the bolt shaft 2340 is advanced down bore 2354, its end will encounter the nut insert end 2362 and bite into it. This will create a frictional resistance to torque. After fastening the cross beam 2200 to clamp sled 2206 and basket portion 2100, this resistance to torque will mitigate any tendency of the nut 2322 to rattle loose from bolt 2134 because of vibration.

The nut insert 2360 may have a radially outwardly disposed head or cap 2364 that may have a noncircular margin 2366, which, in use, will fit into a noncircular depression 2368 in the outer surface 2358. This prevents any tendency of the nut insert 2360 to rotate within insert hole 2356.

In this embodiment, the cross beam 2200 has an upwardly concave plate 2330 that grips the crossbar 102, and a lower elastomeric pad has been omitted.

FIGS. 23A and 27A show the basket portion 1806 being joined to a crossbar 102 of a smaller cross-sectional size. FIG. 27A is taken in a sectional plane parallel to but inboard from the section shown in FIG. 23A. The bolts 2132, 2134 draw up the sleeves 2308, 2310 around clamp sled bolt housings 2552, 2554. Compression of the crossbar 102 against upper pad 2304 indexes the upper surface 2500 of the clamp sled 2206 to a central clamping position on the clamp sled attachment surface 2400, and in particular features such as groove 2524 and wall 2546 will index to the walls of respective ribs 2404. At the same time, the depressions and countersinks will index, in the illustrated position, to a middle five of the bosses 2402.

FIG. 23B shows a basket portion 1806 clamped to a crossbar 2332 of a larger size. The clamp sled bolt housings 2552, 2554 are just within the cross beam sleeves 2308, 2310. The upper surface 2500 of the clamp sled 2206 continues to be indexed to a central clamping position on the clamp sled attachment surface 2400.

FIG. 27B is a longitudinal sectional view of the clamp sled 2206 in a sliding position (when the bolts 2132, 2134 are not installed) as opposed to an indexed clamping position, and corresponds to the transverse sectional view seen in FIG. 27C. The clamp sled lip 2556 is riding on the clamp sled retainer ledge 2610, and all of the clamp sled upper surface 2500 is downwardly displaced from the lowest portions of clamp sled attachment surface 2400. In this condition, the clamp sled may be slid longitudinally, frontward or rearward, and away from a central position. The clamp sled 2206 may, for example, be slid frontward to assume a sliding position corresponding to the clamping position seen in FIG. 27D.

FIG. 27D shows the clamp sled 2206 indexed to a furthest left or frontward one of the predetermined clamping positions. In this “position 1”, the indicator post 2306 will be visible in bolt hole 2118. The bolts 2132, 2134 have drawn up the upper surface 2500 until it is indexed to the attachment surface 2400. The provision of clamp sleds which may be indexed to any of several longitudinally spaced apart clamping positions on the roof basket permits a variance of the longitudinal placement of crossbars 102, 104 on the vehicle V; the roof basket or other carrier may be clamped to the crossbars 102, 104 even if these are moved away from standard positions.

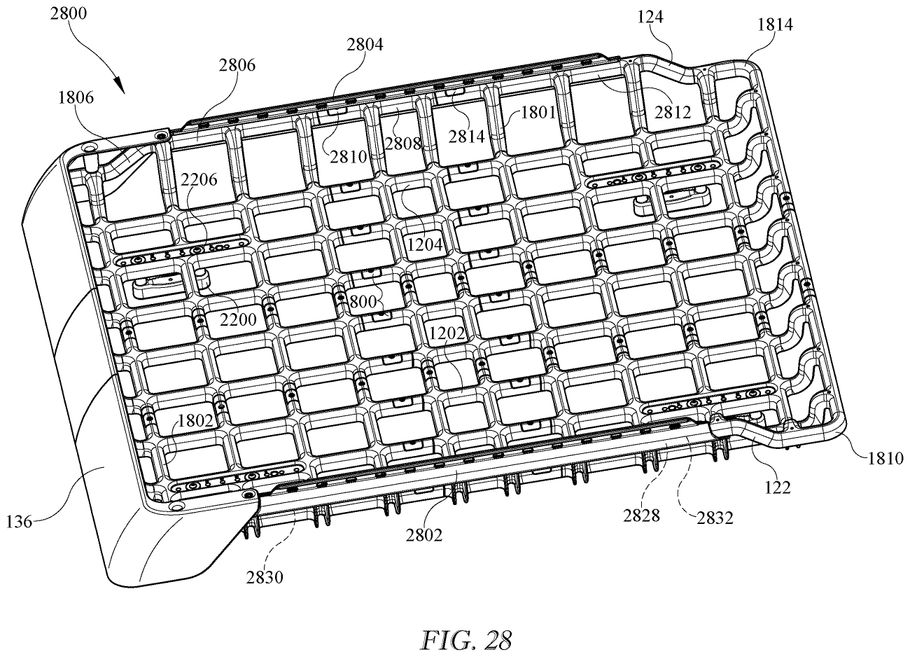

FIG. 28 shows an embodiment 2800 of a roof basket that has had fitted to it two reinforcing rails 2802 and 2804. Each of the rails 2802 and 2084 is fitted to a straight segment of a longitudinal beam, such as left outboard beam 122 and right outboard beam 124. The depicted roof basket configuration is the “max” configuration similar to configuration 1600 illustrated in FIG. 16, although rails 2802 and 2804, or shorter versions of them, may be used in the other roof basket configurations illustrated herein.

Except for the rails 2802 and 2804 and the screws that attach them to underlying structure, the roof basket 2800 is similar in its basic structure to the other roof basket embodiments disclosed herein. Its components still have multiple male free ends and female free ends that fit together and are fastened together using mortise-and-tenon keys 800 and corresponding holes. Rails 2802, 2804 may be used with embodiments that do not employ clamp sleds, such as those shown in FIGS. 1A-17, and also with embodiments that do employ clamp sleds, such as those illustrated in FIGS. 18A-27D. The roof rack body 1801 and the rails 2802 and 2804 may be injection molded using the same polymer compound, such as a polycarbonate/polybutylene terephthalate blend. In one embodiment, there are no metal reinforcements in roof rack body 1801 or rails 2802, 2804.

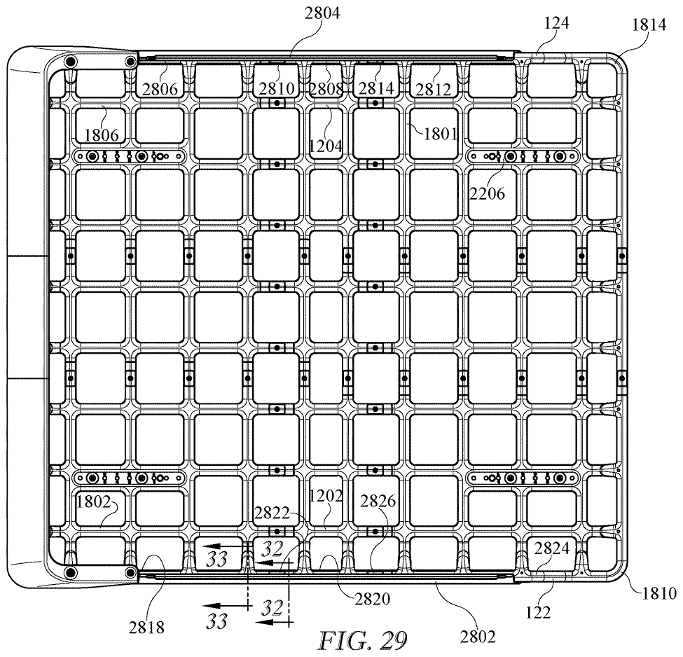

With reference to FIGS. 28 and 29, the body 1801 is assembled from multiple portions, which prior to assembly are separately injection-molded. In the “max” configuration shown in FIGS. 28 and 29, the body portions include left front body portion 1802, left middle outboard portion 1202, left rear body portion 1810, right front body portion 1806, right middle outboard portion 1204, and left rear body portion 1814.

The front right body portion 1806 has a longitudinally oriented outboard beam portion 2806 with a male free end (not visible in FIGS. 28 and 29, nor are the other free ends discussed in the paragraphs which follow) that is similar to male end 2006 as seen in FIG. 20C. The right middle outboard body portion 1204 includes a longitudinally oriented middle outboard beam portion 2808 with a frontward-facing female free end that is substantially similar to end 1308 of FIG. 13, and a rearward-facing male free end that is substantially similar to end 1310 of FIG. 13. The male free end of beam portion 2806 is fastened to the female free end of beam portion 2808 at a fastening location 2810. The structure of fastening location 2810, and of the other fastening locations described herein, may look like the fastening location shown in FIG. 20C. As before, the outer surfaces of the male free ends are inwardly stepped so as to slide into corresponding female free ends. As assembled together, the outer surfaces of the joined beam portions are mathematically cylindrical in that they have an invariant cross section no matter where on their common axis they are taken.

The right rear body portion 1814 has a longitudinally oriented outboard beam portion 2812 with a forward-facing female free end that is similar to end 2022 of FIG. 20C. The free end of rear beam portion 2812 is fastened to the rearward-facing free end of middle beam portion 2808 at a second fastening location 2814, rearwardly spaced from fastening location 2810. Beam portions 2806, 2808 and 2812 constitute right outboard beam 124.

As best seen in FIG. 29, the front left body portion 1802 has a longitudinally oriented front outboard beam portion 2818 with a rearward-facing female free end that is similar to end 2022 of FIG. 20C. The middle left outboard body portion 1202 has a middle outboard beam portion 2820 that is substantially similar to beam portion 1300 of FIG. 13. Middle Beam portion 2820 has a forward-facing male end that is substantially similar to end 1310 of FIG. 13. The male end of beam portion 2820 is fastened to the female end of front beam portion 2818 at a fastening location 2822, which structurally resembles the fastening location seen in FIG. 20C. Middle beam portion 2820 has a rearward-facing female free end that is substantially similar to end 1308 of FIG. 13.

The rear left body portion 1810 has a longitudinally oriented rear outer beam portion 2824 with a forward facing male free end that is similar to end 2006 of FIG. 20C. The male free end of rear beam portion 2824 is fastened to the female free end of middle beam portion 2820 at a fastening location 2826, which may resemble the fastening location shown in FIG. 20C. Beam portions 2818, 2820 and 2824 may constitute a left outboard beam 122.

The male and female free ends as seen in FIG. 20C have certain improvements over the male and female free ends seen, for example, in FIGS. 9 and 13. The rails 2802, 2804 may be used with beam portions terminating in free ends of either embodiment.

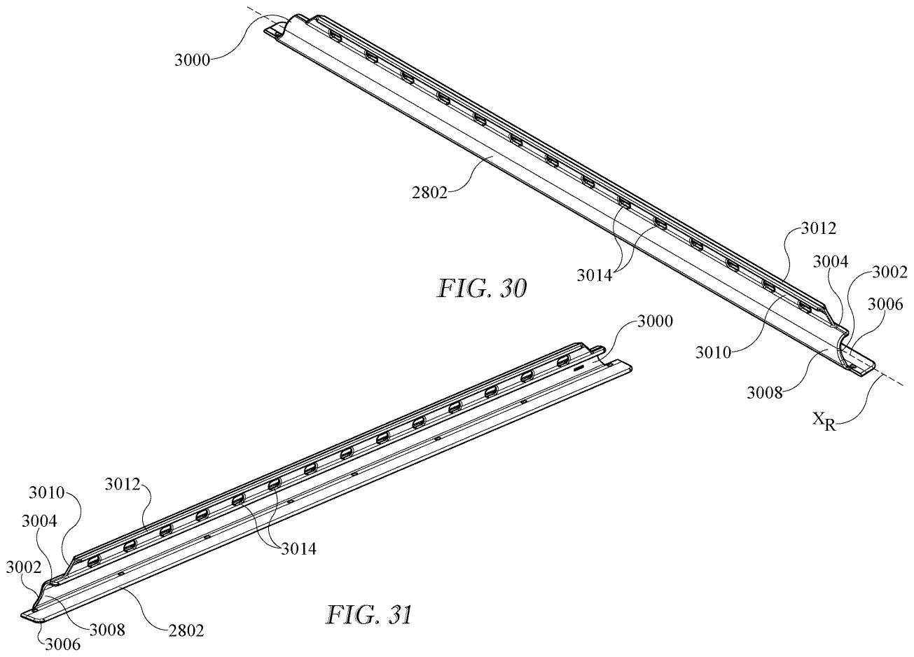

FIGS. 30 and 31 are perspective views from different angles of a reinforcing rail 2802, which may be identical to rail 2804. Rail 2802 is straight, elongate and substantially has a constant axial cross section around its axis X_{R}. A first axial end 3000 of rail 2802 is a mirror image of an opposed, second axial end 3002 thereof.

The rail 2802 has a top portion 3004, a bottom portion 3006 and an outboard or side portion 3008 that joins portion 3004 to portion 3006. A longitudinally elongate vertical plate 3010 extends upwardly from top portion 3004 to a longitudinally elongate horizontal plate 3012. The combination of top portion 3004, vertical plate 3010 and horizontal plate 3012 creates a reinforcing I-beam.

A series of longitudinally spaced-apart, and longitudinally elongate, slots 3014 may be made through vertical plate 3010. Each slot 3014 may accommodate one or more hold-down straps.

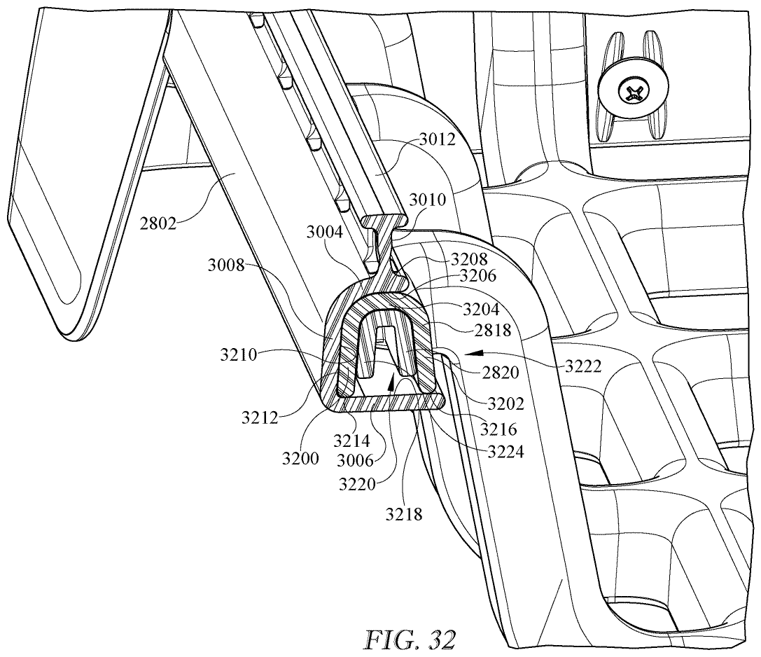

FIG. 32 is a representative cross-sectional view that shows how a rail 2802 closely fits around a beam portion, here outboard beam portion 2818. The outboard beam portion 2818 has an outboard wall 3200, an inboard wall 3202 and a top portion or wall 3204 that joins outboard wall 3200 to inboard wall 3202. Like the rest of the roof basket beam portions, beam portion 2818 forms a downwardly open channel 3220. A lower surface 3206 of rail top portion 3004 closely conforms to a top surface 3208 of the top wall 3204. An inboard surface 3210 of the rail outboard portion 3008 closely conforms to an outboard surface 3212 of the beam outboard wall 3200.

The beam outboard wall 3200 has a lower end 3214 and the beam inboard wall 3202 has a lower end 3216. An upper surface 3218 of bottom portion 3006, which can be planar and substantially horizontal, spans the channel 3220 created by walls 3200 and 3202, to lie adjacent to ends 3214 and 3216. The rail 2802 thus creates an inboard-facing channel 3222 that is roughly at right angles to the channel 3200, giving it different characteristics on how it responds to a force applied at an angle to the rail/beam axis. In particular, the rail 2802 will be stiffer in an inboard/outboard direction than will beam portion 2818. As reinforced, the outboard beam 122, and therefore the roof basket body 1801, will better resist inboard/outboard forces as might occur from wind, tension from the hold-down straps or a user grasping the beam.

The section shown in FIG. 32 is taken near fastening location 2822. Therefore, a male free end 3224 is seen conforming to the interior surfaces of female free end walls 3200, 3202 and 3204. Where the section of the beam portion of which male free end 3224 is a part is taken elsewhere such that its surface is not stepped inward, its wall outer surfaces will be approximately in the same position as walls 3200, 3202 and 3204, and the inner surfaces 3206 and 3210 of the rail 2802 will conform to them.

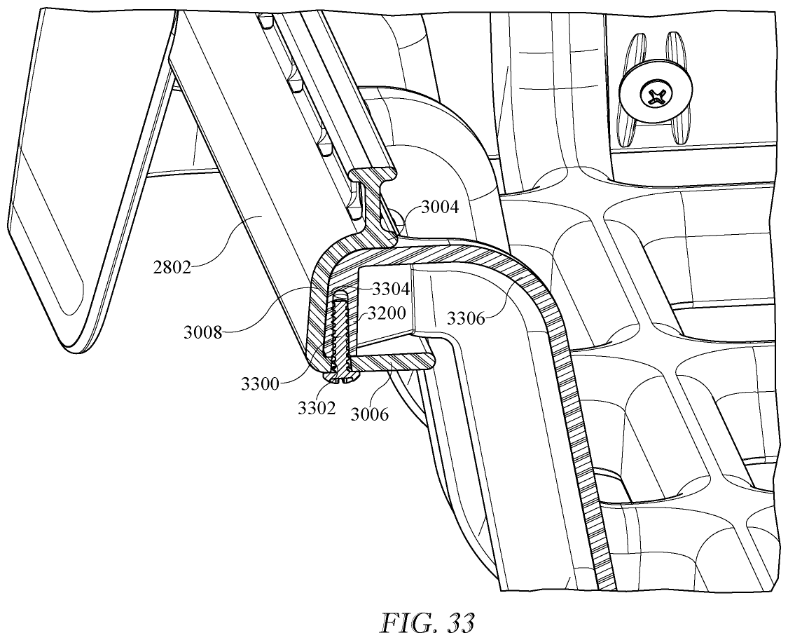

As seen in FIG. 33, a fastening screw 3300 is inserted through a hole 3302 in rail lower portion 3006, and is threaded into a bore 3304 made in beam wall 3200, at the location of its intersection with a co-molded transverse beam portion 3306. Similar screws are used to attach the rail 2802 to the beam portions at longitudinally spaced-apart positions, such as at other intersections of transverse and longitudinal beam portions.

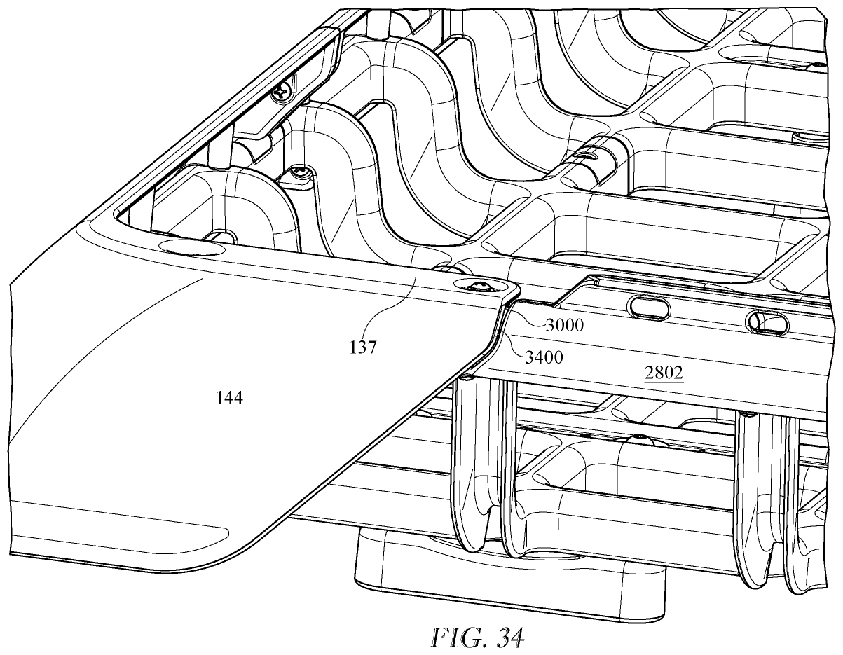

In the detail shown in FIG. 34, the rail end 3000 is seen to conform to a rear edge 3400 of left wind deflector portion 144. Rail end 3002 of right rail 2804 will likewise conform to an edge (not shown) of right wind deflector portion 142. Ends 3000 and 3002 are not straight but are irregular, but because they are mirror images of each other, either rail 2802, 2804 may be installed on either outboard beam 122, 124 of the body 1801, obviating any possibility of misassembly by the end user.

Returning to FIGS. 28 and 29, all of the middle beam portions 2808 and 2820 are straight. Most of beam portions 2806, 2812, 2818 and 2824 are straight, but do have segments that curve at their ends. The rails 2802 and 2804 at least extend over all of the fastening locations in the outboard beams they respectively cover. In the illustrated embodiment, rail 2802 will cover a straight segment 2828 of outboard beam 122, which is most of beam 122. In so doing, the rail 2802 will cover all of middle beam portion 2820, since its straight segment is the same as all of it, a straight segment 2830 of forward outboard beam portion 2818, and a straight segment 2832 of the rear outboard beam portion 2824. This enhanced coverage makes the outboard beam 122 stiffer. The right rail 2804 accords similar coverage and enhanced stiffness to right outboard beam 124 and its beam portions 2806, 2808 and 2812.

In a configuration in which middle beam portions 2808 and 2820 are not used, beam portion 2806 would be directly fastened to beam portion 2812 at a single fastening location, and beam portion 2818 would be fastened to beam portion 2824 at a single fastening location. Shorter reinforcing rails (not shown) would then be provided to cover the single fastening locations, and to cover the reduced length of the straight segments of the outboard beams. Outside of their lengths, the shortened rails may be identical to the illustrated rails 2802 and 2804.

In summary, reinforcing rails have been provided to reinforce the outboard beams of a modular roof rack. The rails are formed as channels that are open in an inboard direction, providing extra inboard-outboard stiffness. The rails may further have reinforcing I-beams with holes for hold-down straps.

While embodiments of the present invention have been described in the above specification and illustrated in the appended drawings, the present invention is not limited thereto but only by the scope and spirit of the appended claims.

We claim:

1. A roof basket for mounting to a roof of a vehicle, the roof basket comprising:
a first body portion of the basket having an elongate, longitudinally oriented first beam portion, the first beam portion having a first free end, a first top surface, a first bottom end and a first side surface extending from the first top surface to the first bottom end;
a second body portion of the basket having an elongate, longitudinally oriented second beam portion, the second beam portion having a second free end, a second top surface, a second bottom end and a second side surface extending from the second top surface to the second bottom end;
the first free end fastened to the second free end at a first fastening location; and
an elongate reinforcing rail fitted to the first beam portion and to the second beam portion so as to extend over the first fastening location, the reinforcing rail being hollow and having a top portion, a bottom portion and a side portion connecting the top portion to the bottom portion, a lower surface of the top portion of the reinforcing rail closely conforming to the first top surface of the first beam portion and to the second top surface of the second beam portion, an inner surface of the side portion of the reinforcing rail closely conforming to the first side surface of the first beam portion and to the second side surface of the second beam portion, a top surface of the bottom portion of the reinforcing rail adjoining the first bottom end of the first beam portion and the second bottom end of the second beam portion.

2. The roof basket of claim 1, wherein the first body portion of the roof basket and the second body portion of the roof basket each have an outboard margin, the first beam portion being disposed at the outboard margin of the first body portion of the basket and the second beam portion being disposed at the outboard margin of the second beam portion of the basket, the first and second beam portions being portions of an outboard beam.

3. The roof basket of claim 1, wherein the roof basket is further comprised of a third body portion that is joined to the second body portion of the basket, the second beam portion having a third free end longitudinally spaced from the second free end, the third body portion having an elongate third beam portion with a fourth free end, the third free end fastened to the fourth free end at a second fastening location longitudinally spaced from the first fastening location; wherein
the reinforcing rail is fitted to the first beam portion, the second beam portion and the third beam portion so as to extend over the first and second fastening locations.

4. The roof basket of claim 3, wherein the first beam portion, the second beam portion and the third beam portion are portions of a longitudinal beam, the longitudinal beam having a longitudinally aligned straight segment, the reinforcing rail longitudinally extending to cover substantially all of the straight segment.

5. The roof basket of claim 1, wherein the first beam portion has a longitudinally aligned first straight segment and the second beam portion has a longitudinally aligned second straight segment, the reinforcing rail longitudinally extending over substantially all of the first and second straight segments.

6. A carrier for mounting to a rooftop of a vehicle, the carrier comprising:
a body molded of a polymer compound, the body having a first body portion and a separately molded second body portion which in use is disposed to a rear of the first body portion;
a longitudinally oriented, elongate first beam portion of the first body portion, the first beam portion having a first outboard wall, a first inboard wall and a first top portion joining the first outboard wall to the first inboard wall, the first outboard wall, first top portion and first inboard wall forming a downwardly open first channel, the first outboard wall and the first top portion having respective first outer surfaces, the first beam portion having a first free end;
a longitudinally oriented, elongate second beam portion of the second body portion, the second beam portion having a second outboard wall, a second inboard wall and a second top portion joining the second outboard wall to the second inboard wall, the second outboard wall, second top portion and second inner wall forming a downwardly open second channel, the second outer wall and the second top portion having respective second outer surfaces, the second beam having a second free end, the second free end fastened to the first free end at a fastening location; and
an elongate reinforcing rail having a top wall, a bottom wall and a sidewall joining the top wall to the bottom wall, the reinforcing rail extending over the fastening location, a lower surface of the top wall of the reinforcing rail fitting to the first outer surface of the first top portion of the first beam portion and to the second outer surface of the second top portion of the second beam portion, an inner surface of the sidewall of the reinforcing rail fitting to the first outer surface of the first outer wall of the first beam portion and to the second outer surface of the second outer wall of the second beam portion, the bottom wall of the reinforcing rail extending across the first channel and across the second channel.

7. The carrier of claim 6, wherein an elongate vertical plate upwardly extends from the top wall of the reinforcing rail, an upper end of the vertical plate terminating in a horizontal plate, the top wall, vertical plate and horizontal plate constituting an I-beam reinforcement.

8. The carrier of claim 7, wherein the vertical plate is longitudinally elongate, and wherein a plurality of longitudinally spaced-apart hold down slots are formed in the vertical plate.

9. The carrier of claim 6, wherein the body has a third body portion molded separately from the first body portion and the second body portion, the third body portion having a longitudinally disposed third beam portion with a fourth free end, the second beam portion having a third free end longitudinally spaced from the second free end, the fastening location being a first fastening location, the third free end fastened to the fourth free end at a second fastening location longitudinally spaced from first fastening location, the reinforcing rail fitting to the first, second and third beam portions and extending over the second fastening location.

10. The carrier of claim 6, wherein the carrier is a roof basket, the body of the carrier comprising a plurality of elongate spaced apart longitudinal beams and a plurality of elongate spaced apart transverse beams which intersect the longitudinal beams, one of the longitudinal beams including the first beam portion and the second beam portion, said one of the longitudinal beams having a longitudinally aligned straight segment, the reinforcing rail longitudinally extending to cover substantially all of the straight segment.

11. The carrier of claim 6, wherein the first beam portion and the second beam portion are portions of an outboard beam.

12. A carrier for mounting to a rooftop of a vehicle, the carrier comprising:
a body molded of a polymer compound, the body having a first body portion and a separately molded second body portion which in use is disposed to a rear of the first body portion;
a longitudinally oriented, elongate first beam portion of the first body portion, the first beam portion forming a downwardly open first channel, the first beam portion having a first free end;
a longitudinally oriented, elongate second beam portion of the second body portion, the second beam portion forming a downwardly open second channel, the second beam portion having a second free end, the second free end fastened to the first free end at a fastening location; and
an elongate reinforcing rail forming a channel which is open in a transverse direction, the reinforcing rail fitted around the first beam portion and the second beam portion so as to extend over the fastening location.

13. The carrier of claim 12, wherein the reinforcing rail is formed as a channel which is open in the inboard direction.

14. The carrier of claim 12, wherein the reinforcing rail has a top portion bounding the channel of the reinforcing rail, a longitudinally elongate vertical plate upwardly extending from the top portion to a longitudinally elongate horizontal plate, the top portion, vertical plate and horizontal plate forming a reinforcing I-beam.

15. A roof basket for mounting to the rooftop of a vehicle, the roof basket comprising:
a plurality of elongate spaced apart longitudinal beams and a plurality of elongate spaced apart transverse beams which intersect the longitudinal beams, at least the longitudinal beams being formed as downwardly open channels;
the longitudinal beams including left and right outboard beams, each outboard beam having a longitudinally aligned straight segment; and
for each outboard beam, a reinforcing rail longitudinally extending to cover substantially all of the straight segment of the outboard beam, the reinforcing rail formed as a channel open in an inboard direction, the reinforcing rail fitted around the outboard beam.

16. The roof basket of claim 15, wherein the reinforcing rail has a top portion, a longitudinally elongate vertical plate upwardly extending from the top portion to a longitudinally elongate horizontal plate, the top portion, vertical plate and horizontal plate forming a reinforcing I-beam.

17. The roof basket of claim 15, wherein the longitudinal beams, transverse beams and reinforcing rails are molded of one or more polymer compounds and do not have metal reinforcements.
